(19) United States
(12) Patent Application Publication
(10) Pub. No.: US 2006/0240358 A1
(43) Pub. Date: Oct. 26, 2006

(54) Pretreatment compositions

(75) Inventors: David B. Powell, Minnetonka, MN (US); Ahmad A. Naiini, East Greenwich, RI (US); N. Jon Metivier, Billerica, MA (US); Donald F. Perry, North Providence, MA (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: FUJIFILM ELECTRONIC MATERIALS U.S.A., INC.

(21) Appl. No.: 11/386,958

(22) Filed: Mar. 22, 2006

Related U.S. Application Data
(60) Provisional application No. 60/665,172, filed on Mar. 25, 2005.

(51) Int. Cl. G03C 5/00

(52) U.S. Cl. 430/311

(57) ABSTRACT

A pretreatment composition for treating a substrate to be subjected to forming a relief pattern thereon by exposure to actinic radiation, the pretreatment composition comprising:
(a) at least one compound having Structure VI 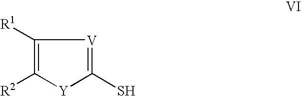
wherein, V is selected from CH and N, Y is selected from O and NR³ wherein R³ is selected from H, CH₃ and C₂H₅, R¹ and R² are each independently selected from H, a C₁-C₄ alkyl group, a C₁-C₄ alkoxy group, cyclopentyl and cyclohexyl, or alternatively, R¹ and R² can be fused to produce a substituted or unsubstituted benzene ring, with the proviso that the substituent is not an electron withdrawing group, (b) at least one organic solvent, and optionally, (c) at least one adhesion promoter; wherein the amount of the compound of Structure VI present in the composition effective to inhibit residue from forming when the photosensitive composition is coated on a substrate and the coated substrate is subsequently processed to form an image on the substrate. Processes for pretreatment of substrates and processes for forming relief images on pretreated substrates are disclosed.

### RELATED APPLICATIONS

This application claims priority from Provisional Patent Application No. 60/665172, filed Mar. 25, 2005.

### FIELD OF THE INVENTION

The present invention relates to copper compatible pretreatment compositions and a process of use for said compositions, and electronic parts produced by said process of use. More specifically, the present invention relates to use of a pretreatment composition with both photosensitive and non-photosensitive buffer coat compositions.

### BACKGROUND OF THE INVENTION

In microelectronic applications, polymers that demonstrate high temperature resistance, such as polyimides and polybenzoxazoles, are generally well known. Precursors of such polymers, can be made photoreactive with suitable additives. The precursors are converted to the desired polymer by known techniques such as exposure to high temperatures. The polymer precursors are used to prepare protective layers, insulating layers, and relief structures of highly heat-resistant polymers.

As the dimensions of photolithographic patterns on wafers continue to shrink below 0.15 microns, greater demands continue to be placed on lithographic equipment and materials. To meet this challenge, the semiconductor industry is changing from aluminum based alloys and silicon dioxide to copper metal and low dielectric constant (low-k) materials to manufacture chips. Copper is known to have as much as 40% decreased electrical resistance. Moreover, when using low-k materials there is a decrease in capacitance, which is critical to improving integrated circuit performance, especially for higher density memory chips. More and more, the metal substrate and inter-dielectric layer materials are changing from aluminum based alloys and silicon dioxide to copper metal and the new low-k dielectrics. Copper has lower electrical resistance, carries higher current densities, and has improved electromigration resistance compared to aluminum. Thus, copper interconnects allow decreasing transistor size and shorter connections that result in faster, more powerful devices. Fabrication costs are also lower than with aluminum since copper is less expensive and requires fewer processing steps to produce devices.

Copper metallization provides a challenge to the semiconductor industry since copper can act as a catalyst and destabilize systems that are optimized for coating over aluminum. In addition, cuprous and cupric ions present on the copper surface can bind strongly with some polymers and reduce the ability to dissolve the polymers during certain wafer coating processes, which leaves undesired and detrimental residues behind. With the increased use of copper metallization in semiconductor devices, it is important to develop photosensitive coating systems that are compatible with copper and copper processing.

### SUMMARY OF THE INVENTION

The present invention is directed to a pretreatment composition comprising:
(a) at least one compound having Structure VI 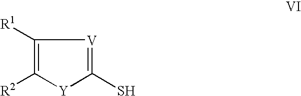
wherein, V is CH or N, Y is O or NR³ wherein R³ is H, CH₃ or C₂H₅, R¹ and R2 each independently are H, a C ₁-C ₄ alkyl group, a C₁-C₄ alkoxy group, cyclopentyl or cyclohexyl or alternatively, R¹ and R² can be fused to produce a substituted or unsubstituted benzene ring, with the proviso that the substituent is not an electron withdrawing group,
(b) at least one organic solvent, and optionally,
(c) at least one adhesion promoter;
   wherein the amount of the compound of Structure VI present in the composition is effective to inhibit residue from forming when the photosensitive composition is coated on a substrate and the coated substrate is subsequently processed to form an image on the substrate. This effective amount of compound of Structure VI will vary depending upon, at least the following, the amount of organic solvent employed, the specific organic solvent employed, and the specific compound of Structure VI employed. The form of the pretreatment composition is a non-aqueous composition.

The present invention also is directed to processes for forming relief patterns and electronic parts using the composition.

### DETAILED DESCRIPTION OF THE INVENTION

One embodiment of the present invention is directed to a pretreatment composition comprising:
(a) at least one compound having Structure VI 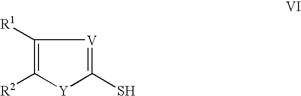
wherein, V is CH or N, Y is O or NR³ wherein R³ is H, CH₃ or C₂H₅, R¹ and R² each independently are H, a C₁-C₄ alkyl group, a C₁-C₄ alkoxy group, cyclopentyl or cyclohexyl or alternatively, R¹ and R² can be fused to produce a substituted or unsubstituted benzene ring, with the proviso that the substituent is not an electron withdrawing group,
(b) at least one organic solvent, and optionally,
(c) at least one adhesion promoter;
   wherein the amount of the compound of Structure VI present in the composition is an amount of the compound of Structure VI that along with the amount of the organic solvent present in the composition is effective to inhibit residue from forming when the composition is coated on a substrate and the coated substrate is subsequently processed to form an image on the substrate.

Compounds generally described by Structure VI can also exist (and may preferentially exist) in the tautomeric form VI in certain situations. For the purposes of the description of this invention, both tautomeric forms are considered to be described by Structure VI.

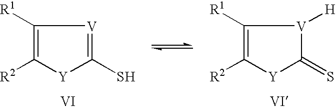

Preferred compounds having Structure VI include but are not limited to Structures VI-a or VI-b or VI-c or VI-d: 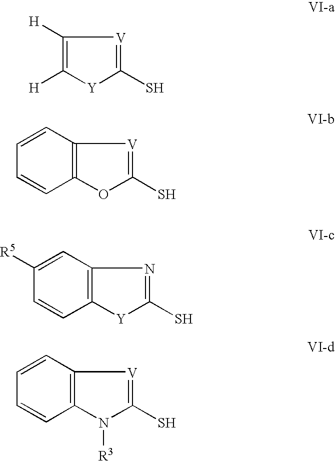
wherein, the definitions of V, Y and R³ are the same as defined earlier and R⁵ is H or a monovalent electron donating group. Examples of monovalent electron donating groups include, but are not limited to, a C₁-C₄ alkyl group, a C₁- C₄ alkoxy group, cyclopentyl or cyclohexyl.

In the alternative tautomeric form, preferred compounds VI-a-VI-d would be

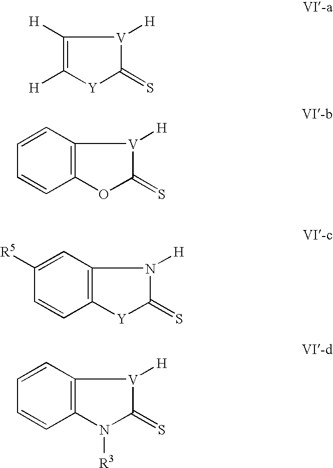

Examples of compounds having Structure VI include but are not limited to:

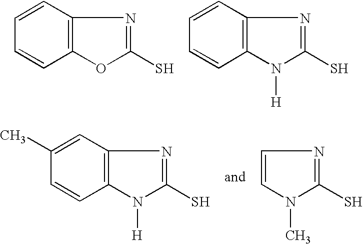

Suitable organic solvents of this composition are mildly polar to strongly polar organic solvents. Suitable examples of such organic solvents include, but are not limited to, N-methyl-2-pyrrolidone (NMP), N-ethyl-2-pyrrolidone (NEP), gamma-butyrolactone (GBL), N,N-dimethylacetamide (DMAc), dimethyl-2-piperidone, N,N-dimethylformamide (DMF), ketones such as 2-pentanone, cyclopentanone, 2-hexanone, and 2-heptanone, esters such as propylene glycol monomethyl ether acetate, ethyl acetate, methyl methoxypropionate, ethyoxyethyl propionate, and ethyl lactate, alcohols such as 1-methoxy-2-propanol, and 1-pentanol, and mixtures thereof. The preferred solvents are gamma-butyrolactone and N-methyl-2-pyrrolidone. The most preferred solvent is gamma-butyrolactone.

The effective amount of compound having Structure VI may vary depending on the particular compound employed and the amount and particular organic solvent employed. In general, the amount of compound having Structure VI used in this composition is from about 0.5 wt. % to about 25 wt. % of the total weight of the composition, preferably, from about 0.75 wt. % to about 18 wt. %, and more preferably, from about 1.0 wt. % to about 15 wt. %. In some cases the effective amount of compound having Structure VI may not be soluble in a preferred solvent so an alternative solvent must be selected.

The organic solvent component (b) comprises from about 75 wt. % to about 99.5 wt. % of the composition. A preferred solvent range is from about 82 wt. % to about 99.25 wt. %. A more preferred range of solvent is from about 85 wt. % to about 99 wt. %.

Optionally, an adhesion promoter may be included in the composition. If employed, the amount of adhesion promoter ranges from about 0.1 wt. % to about 2 wt. % of total weight of composition. A preferred amount of adhesion promoter is from about 0.2 wt. % to about 1.5 wt. %. A more preferred amount of adhesion promoter is from about 0.3 wt. % to about 1 wt. %. Suitable adhesion promoters include, for example, amino silanes, and mixtures or derivatives thereof. Examples of suitable adhesion promoters which may be employed in the invention may be described by Structure XIV 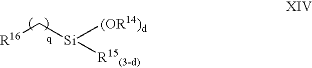
wherein each R¹⁴ is independently a C₁-C₄ alkyl group or a C₅-C₇ cycloalkyl group and each R¹⁵ is independently a C₁-C₄ alkyl group, a C₁-C₄ alkoxy group, a C₅-C₇ cycloalkyl group or a C₅-C₇ cycloalkoxy group; d is an integer from 0 to 3 and q is an integer from 1 to about 6, and R¹⁶ is one of the following moieties: 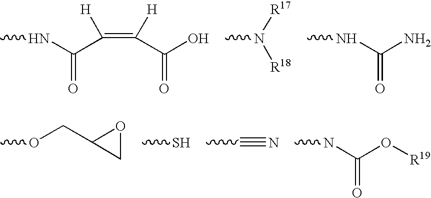
wherein each R¹⁷ and R¹⁸ are each independently a C₁-C₄ alkyl group or a C₅-C₇ cycloalkyl group, and R¹⁹ is a C₁-C₄ alkyl group or a C₅-C₇ cycloalkyl group. Preferred adhesion promoters are those wherein R¹⁶ are 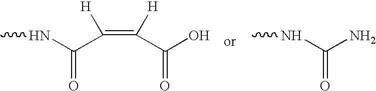
More preferred adhesion promoters are those wherein R¹⁶ is 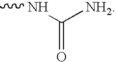
The most preferred adhesion promoters are

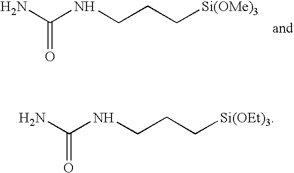

The compositions of the present invention may further include other additives. Suitable additives include, for example, leveling agents, surfactant and the like. Such additives may be included in the pretreatement compositions in about 0.03 wt % to about 10 wt % of the total weight of composition.

The composition of this embodiment may be employed to produce electronic components such as semiconductor devices and multi-layered interconnections boards.

Another embodiment of the present invention is directed to a process for forming a relief pattern using a positive tone photosensitive composition containing at least one polybenzoxazole precursor polymer. The process comprises the steps of:
(a) pretreating a substrate using a pretreatment composition comprising one or more compounds of Structure VI, an organic solvent, and optionally an adhesion promoter,
(b) coating on the pretreated substrate, a positive-working photosensitive composition comprising at least one polybenzoxazole precursor polymer, at least one diazonaphthoquinone photoactive compound, and at least one solvent, thereby forming a coated substrate,
(c) baking the coated substrate,
(d) exposing the baked coated substrate to actinic radiation, and
(e) developing the exposed coated substrate with an aqueous developer, thereby forming an uncured relief image on the coated substrate.

The process may include other optional steps. Examples of optional steps include, but are not limited to the steps of post exposure baking the exposed coated substrate at an elevated temperature prior to developing, rinsing the developed relief image and substrate after development, and treating the substrate with an adhesion promoter. Typically the latter optional step is not done when an adhesion promoter is included in the photosensitive composition or the pretreatment composition.

Any suitable method of treatment of the substrate with adhesion promoter known to those skilled in the art may be employed. Examples include treatment of the substrate with adhesion promoter vapors, solutions or at 100% concentration. The time and temperature of treatment will depend on the particular substrate, adhesion promoter, and method, which may employ elevated temperatures. Any suitable external adhesion promoter may be employed. Classes of suitable external adhesion promoters include but are not limited to vinylalkoxysilanes, methacryloxyalkoxyysilanes, mercaptoalkoxysilanes, aminoalkoxysilanes, epoxyalkoxysilanes and glycidoxyalkoxysilanes. Aminosilanes and glycidoxysilanes are more preferred. Primary aminoalkoxysilanes are more preferred. Examples of suitable external adhesion promoters include, but are not limited to gamma-aminopropyltrimethoxy-silane, gamma-glycidoxypropylmethyldimethoxysilane, gamma-glycidoxypropyl-methyldiethoxysilane, gamma-mercaptopropylmethyidimethoxysilane, 3-methacryl-oxypropyldimethoxymethylsilane, and 3-methacryloxypropyltrimethoxysilane. gamma-Aminopropyltrimethoxysilane is more preferred. Additional suitable adhesion promoters are described in “Silane Coupling Agent” Edwin P. Plueddemann, 1982 Plenum Press, New York. The adhesion promoter treatment may take place before or after the pretreatment with the pretreatment composition containing one or more compounds of Structure VI.

Suitable substrates such as a copper wafer are first pretreated by the composition of this invention. The substrate may be, for example, semiconductor materials such as a silicon wafer or a ceramic substrate, glass, copper or other metal, or plastic. The most preferred substrate is a copper substrate.

The pretreatment of the substrate can be accomplished in a variety of ways. The substrate must be brought into contact with the pretreatment composition so as to completely cover at least the surface of the substrate to be treated, for a short period of time and then dried.

Application of the pretreatment composition can be carried out by numerous means known to those in the art. Examples of application means include, but, are not limited to, stream, spray, mist with the pretreatment composition, and immersion of the substrate into a bath of the pretreatment composition. The substrate may be rotating, static, or otherwise moving during this application as long as the pretreatment composition is distributed evenly over the surface and not removed too rapidly. Preferred application means for the pretreatment composition include spray and stream onto the substrate placed horizontally on a spin chuck in the center of a spin bowl on a coating tool.

When contacting the pretreatment composition with the substrate in the spin bowl, the spin speed of the substrate during application of the pretreatment composition and contact time thereafter can range from about 0 rpm to about 2000 rpm for about 1 second to about 100 seconds. Higher spin speeds tend to result in uneven treatment of the substrate. A preferred spin speed range is from about 50 rpm to about 1500 rpm. A more preferred spin sped range is from about 100 rpm to about 500 rpm. The pretreatment composition may be applied with the substrate at 0 rpm until the desired contact time is complete. Alternatively, the pretreatment composition may be applied while the substrate is rotating so as to spread the pretreatment composition rapidly over the substrate and then de-accelerated to 0 rpm. Alternatively, the substrate may continue spinning during the contact time.

The rate at which the pretreatment composition is applied, and the volume of pretreatment composition necessary, may vary somewhat with the specific method and time employed, the size of the substrate, and the rotational speed, if employed. Routine experimentation by those skilled in the art can determine exact volumes. A preferred process dispenses 3 mL of pretreatment composition onto a substrate spinning at 200 rpm during a ten second period.

The pretreatment composition should remain in contact with the substrate from about 1 second to about 100 seconds. A preferred contact time between the substrate and the pretreatment composition is from about 4 seconds to about 20 seconds. A more preferred contact time between the substrate and the pretreatment composition is from about 5 seconds to about 10 seconds.

The temperature of the pretreatment composition may range from about 5° C. to about 45° C. Preferably, the temperature ranges from about 15° C. to about 35° C. More preferably, the temperature ranges from about 20° C. to about 30° C.

After the desired contact time has been achieved, the substrate is dried. Numerous drying means known to those in the art may be employed. Examples of suitable drying means include, but are not limited to, air drying, blowing with a stream of nitrogen, baking, or spinning or combinations thereof. Suitable baking means are known to those skilled in the art. Examples of suitable baking means include, but are not limited to, hot plates, and thermal or infrared ovens. The preferred drying means is spinning the substrate. Specific drying means may be preferred based on the contact method. For example, for contact in the spin bowl, spin drying or hot plate bake are preferred. For an immersion contact method, a nitrogen stream or a multi-wafer spin dry system may be preferred.

The time required for drying will depend on the specific drying means employed, the temperature, and the solvent of the pretreatment composition. Higher boiling solvents will require more vigorous drying means such as longer times or higher temperatures. Bakes at about 40° C. to about 120° C. for about 20 seconds to about 60 seconds are suitable. Spin drying can be accomplished by spinning the substrate at from about 500 rpm to about 1000 rpm for from about 50 seconds to about 120 seconds. Alternatively, higher spin speeds for shorter times may be employed such as 2000 rpm for 20-50 seconds. There are no known problems with longer contact times. However, throughput will suffer with longer contact times. Those skilled in the art can easily determine suitable conditions for the specific combinations of elements employed without undue experimentation.

One positive photosensitive resin composition that can be used in this invention comprises at least one polybenzoxazole precursor polymer, at least one diazonaphthoquinone photoactive compound, and at least one solvent.

The composition comprises at least one polybenzoxazole precursor polymer having Structures I, II, III*, IV or IV*, or V. 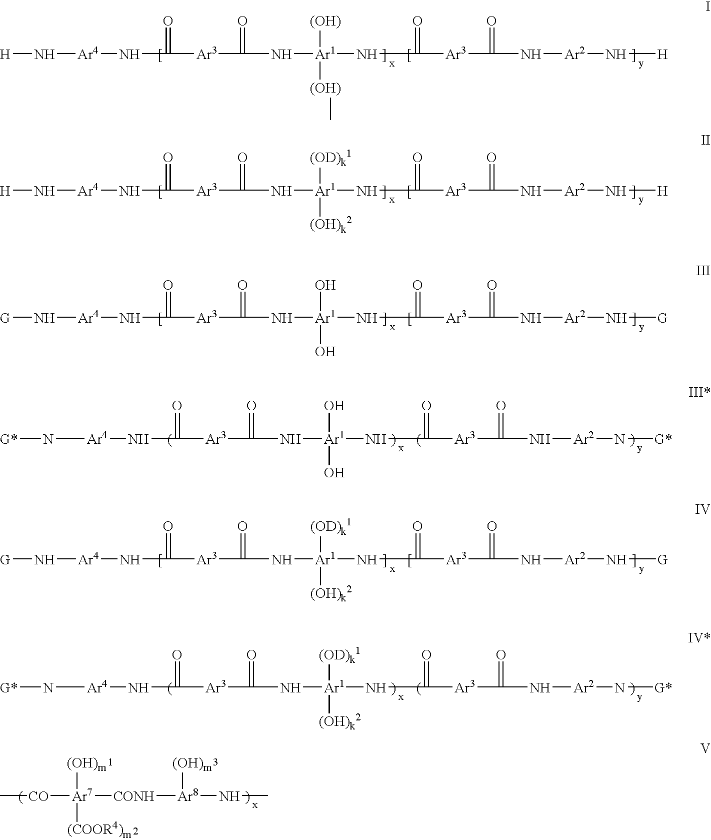
wherein Ar¹ is a tetravalent aromatic group, a tetravalent heterocyclic group, or mixtures thereof; Ar² is a divalent aromatic, a divalent heterocyclic, a divalent alicyclic, or a divalent aliphatic group that may contain silicon; Ar³ is a divalent aromatic group, a divalent aliphatic group, a divalent heterocyclic group, or mixtures thereof; Ar⁴ is Ar¹ (OH)₂ or Ar², x is from about 10 to about 1000; y is from 0 to about 900; D is one of the following moieties: 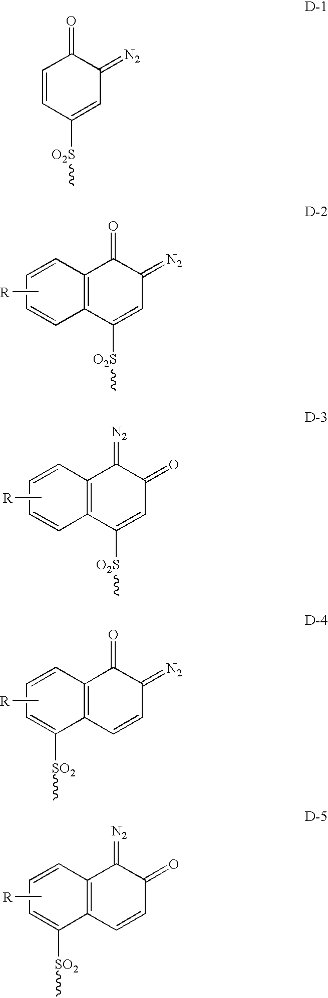
wherein, R is H, halogen, a C₁-C₄ alkyl group, a C₁-C₄ alkoxy group, cyclopentyl, or cyclohexyl; k¹ can be any positive value of up to about 0.5, k² can be any value from about 1.5 to about 2 with the proviso that (k¹+k²)=2, G is a monovalent organic group having a carbonyl, carbonyloxy or sulfonyl group, G* is a divalent organic group having at least one carbonyl or sulfonyl group; Ar⁷ represents a bivalent to octavalent organic group with at least two carbon atoms, Ar⁸ represent a bivalent to hexavalent organic group with at least two carbon atoms, and R⁴ represent hydrogen or an organic group with 1 to 10 carbons, m¹ and m³ are integers in the range of 0 to 4 but m¹ and m³ cannot be simultaneously 0 and m² is an integer in the range of 0 to 2.

The diazonaphthoquinone (DNQ) photoactive compound of the photosensitive resin composition comprises one or more diazonaphthoquinone photoactive compounds which are the condensation products of compounds containing from 2 to about 9 aromatic hydroxyl groups with a 5-naphthoquinone diazide sulfonyl compound (e.g. chloride) and/or a 4-naphthoquinone diazide sulfonyl compound (e.g. chloride) to yield aromatic sulfonate esters containing the moieties D-2 and/or D-4. Examples of suitable diazonaphthoquinones can be found in the references cited below for photosensitive compositions suitable for use in this embodiment.

Suitable solvents of this photosensitive composition are polar organic solvents. Suitable examples of polar organic solvents include but are not limited to, N-methyl-2-pyrrolidone (NMP), gamma-butyrolactone (GBL), N,N-dimethylacetamide (DMAc), dimethyl-2-piperidone, N,N-dimethylformamide (DMF), and mixtures thereof. The preferred solvents are gamma-butyrolactone and N-methyl-2-pyrrolidone. The most preferred solvent is gamma-butyrolactone.

Examples of positive tone photosensitive compositions suitable for use in this embodiment include, but are not limited to, those described in U.S. Pat. No. 4,849,051, U.S. Pat. No. 5,037,720, U.S. Pat. No. 5,081,000, U.S. Pat. No. 5,376,499, U.S. Pat. No. 5,449,584, U.S. Pat. No. 6,071,666, U.S. Pat. No. 6,120,970, U.S. Pat. No. 6,127,086, U.S. Pat. No. 6,153,350 U.S. Pat. No. 6,177,255, U.S. Pat. No. 6,214,516, U.S. Pat. No. 6,232,032, U.S. Pat. No. 6,235,436 B1, U.S. Pat. No. 6,376,151, U.S. Pat. No. 6,524,764, U.S. Pat. No. 6,607,865, US Patent Publication No. 2004/0142275, US Patent Publication No. 2004/0229160, US Patent Publication No. 2004/0229167, and US Patent Publication No. 2004/0249110, which are all hereby incorporated by reference.

The positive acting, photoactive composition is coated on top of the pre-treated substrate. Coating methods include, but are not limited to spray coating, spin coating, offset printing, roller coating, screen printing, extrusion coating, meniscus coating, curtain coating, and immersion coating. The resulting film is prebaked at an elevated temperature. The bake may be completed at one or more temperatures within the temperature bake of from about 70° C. to a bout 120° C. for several minutes to half an hour, depending on the method, to evaporate the remaining solvent. Any suitable baking means may be employed. Examples of suitable baking means include, but are not limited to, hot plates and convection ovens. The resulting dry film has a thickness of from about 3 microns to about 50 microns or more preferably from about 4 microns to about 20 microns or most preferably from about 5 microns to about 15 microns.

After the bake step, the resulting dry film is exposed to actinic rays in a preferred pattern through a mask. X-rays, electron beam, ultraviolet rays, visible light, and the like can be used as actinic rays. The most preferable rays are those with wavelength of 436 nm (g-line) and 365 nm (i-line).

Following exposure to actinic radiation, in an optional step, it may be advantageous to bake the exposed and coated substrate to a temperature between about 70° C. and 120° C. The exposed and coated substrate is heated in this temperature range for a short period of time, typically several seconds to several minutes and may be carried out using any suitable heating means. Preferred baking means include baking on a hot plate or in a convection oven. This process step is commonly referred to in the art as post exposure baking.

Next, the film is developed using an aqueous developer and a relief pattern is formed. The aqueous developer contains aqueous base. Examples of suitable bases include, but are not limited to, inorganic alkalis (e.g., potassium hydroxide, sodium hydroxide, ammonia water), primary amines (e.g., ethylamine, n-propylamine), secondary amines (e.g. diethylamine, di-n-propylamine), tertiary amines (e.g., triethylamine), alcoholamines (e.g. triethanolamine), quaternary ammonium salts (e.g., tetramethylammonium hydroxide, tetraethylammonium hydroxide), and mixtures thereof. The concentration of base employed will vary depending on the base solubility of the polymer employed and the specific base employed. The most preferred developers are those containing tetramethylammonium hydroxide (TMAH). Suitable concentrations of TMAH range from about 1% to about 5%. In addition, an appropriate amount of a surfactant can be added to the developer. Development can be carried out by means of immersion, spray, puddle, or other similar developing methods at temperatures from about 10° C. to about 40° C. for about 30 seconds to about 5 minutes. The development may occur in two stages where fresh developer is applied after an initial development period. This is a useful technique when developing thick films as the activity of the developer may become lower due to dissolution of the exposed photosensitive composition.

After development, the relief pattern may be optionally rinsed using deionized water and dried by spinning, baking on a hot plate, in an oven, or other suitable means.

The benzoxazole ring is then formed by curing of the uncured relief pattern to obtain the final high heat resistant pattern. 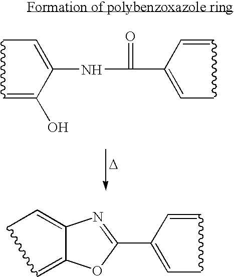
Curing is performed by baking the developed, uncured relief pattern at or above the glass transition temperature (T_{g}) of the photosensitive composition to obtain the benzoxazole ring that provides high heat resistance. Typically, temperatures above about 200° C. are used. Preferably, temperatures from about 250° C. to about 400° C. are applied. The curing time is from about 15 minutes to about 24 hours depending on the particular heating method employed. A more preferred range for the curing time is from about 20 minutes to about 5 hours and the most preferred range of curing time is from about 30 minutes to about 3 hours. Curing can be done in air or preferably, under a blanket of nitrogen and may be carried by any suitable heating means. Preferred means include baking on a hot plate or in a convection oven.

The process of this embodiment may be employed to produce electronic components such as semiconductor devices and multi-layered interconnections boards.

Another embodiment of the present invention is directed to a process for forming a relief pattern using a chemically amplified positive tone photosensitive composition containing a polybenzoxazole precursor polymer. The process comprises the steps of:
(a) pretreating a substrate using a pretreatment composition comprising one or more compounds of Structure VI, an organic solvent, and optionally an adhesion promoter;
(b) coating on said pretreated substrate, a positive-working photosensitive composition comprising at least one polybenzoxazole precursor polymer bearing at least one acid labile functional group; at least one photo acid generator (PAG) and at least one solvent,
(c) baking the coated substrate,
(d) exposing the coated substrate to actinic radiation,
(e) post exposure baking the coated substrate at an elevated temperature, and
(f) developing the coated substrate with an aqueous developer, thereby forming an uncured relief image.

The process may include other optional steps. Examples of optional steps include, but are not limited to, the steps of rinsing the developed relief image and substrate after development, and treating the substrate with an adhesion promoter as described in an earlier embodiment. Typically the latter optional step is not done when an adhesion promoter is included in the photosensitive composition or the pretreatment composition.

In this embodiment, the suitable substrates, treatment composition, and treatment process are as described previously.

The chemically amplified positive tone photosensitive composition comprises:
(a) At least one polybenzoxazole precursor bearing at least one acid labile functional group
(b) at least one photoactive compound which releases acid upon irradiation (PAG), and
(c) at least one solvent.

Optionally, the photosensitive composition may contain other additives which include but are not limited to photosensitizers, adhesion promoters, and leveling agents.

Examples of polybenzoxazole precursor polymers bearing at least one acid labile functional group, PAGs, and positive photosensitive resin compositions that are suitable for use in this embodiment include, but are not limited to, those described in U.S. Pat. No. 6,143,467, US Patent Publication No. 2002/0037991, US Patent Publication No. 2003/0099904, US Patent Publication No. 2003/0087190, US Patent Publication No. 2003/0100698, US Patent Publication No. 2003/0104311, US Patent Publication No. 2003/0134226 and US Patent Publication No. 2004/0253542, all hereby incorporated by reference.

The positive acting, photosensitive compositions comprising at least one polybenzoxazole precursor polymer suitable for this embodiment are coated onto a suitable substrate. The coating, baking, exposing, developing and curing steps are as described previously.

Subsequent to the baking step, the resulting film is exposed to actinic rays through a mask. X-rays, electron beam, ultraviolet rays, visible lights and the like can be used as actinic rays. The preferred rays are those with wavelength of 436 nm (g-line), 365 nm (i-line) and 248. The most preferred rays are those with wavelength of 248 nm and 365 nm.

Following exposure to actinic radiation, it is advantageous to heat the coated substrate to a temperature between about 50° C. and about 150° C. The coated substrate is heated within this temperature range for a short period of time, typically several seconds to several minutes. This process step is commonly referred to in the art as post exposure baking.

The process of this embodiment may be employed to produce electronic components such as semiconductor devices and multi-layered interconnections boards.

Another embodiment of the present invention is direct to a process for forming a relief pattern using a negative tone photosensitive composition containing a polybenzoxazole precursor polymer. The process in this embodiment comprises:
(a) pretreating a substrate using a pretreatment composition comprising one or more compounds of Structure VI, an organic solvent, and optionally an adhesion promoter,
(b) coating on said substrate, a negative-working photosensitive composition comprising at least one polybenzoxazole precursor polymer, at least one photoactive compound which releases acid upon irradiation, at least one latent crosslinker, and at least one solvent,
(c) baking the coated substrate,
(d) exposing the coated substrate to actinic radiation,
(e) post exposure baking the coated substrate at an elevated temperature, and
(f) developing the coated substrate with an aqueous developer, thereby forming an uncured relief image.

The process may include other optional steps. Examples of optional steps include, but are not limited to, the steps of rinsing the developed relief image and substrate after development, and treating the substrate with an adhesion promoter as described in an earlier embodiment. Typically the latter optional step is not done when an adhesion promoter is included in the photosensitive composition or the pretreatment composition.

In this embodiment, the suitable substrates, the treatment composition, and the treatment process are as described previously. The negative acting, photosensitive compositions suitable for this embodiment are coated onto a suitable substrate. The coating, baking, exposing, developing and curing steps are as described previously.

Examples of negative-working photosensitive compositions suitable for this embodiment comprises one or more polybenzoxazole precursor polymers having Structure I or III or III* or mixtures thereof, as described earlier.

The negative-working photosensitive compositions useful in this embodiment use photoactive compounds that release acid upon irradiation. Such materials are commonly called Photo-Acid Generators (PAGs). The PAG is matched with the particular wavelength of light being employed so that the photoacid can be generated. Examples of the classes of PAGs useful in the negative-working photosensitive compositions include, but are not limited to oxime sulfonates, triazides, diazoquinone sulfonates, or sulfonium or iodonium salts of sulfonic acids.

Alternatively, the photoacid could be generated by a combination of a PAG and a sensitizer. In such systems energy of radiation is absorbed by the sensitizer and transmitted in some manner to the PAG. The transmitted energy causes PAG decomposition and generation of photoacid. Any suitable photoacid generator compound may be used. Suitable classes of photoacid generators useful in combination with a sensitizer include, but are not limited to, sulfonium or iodonium salts, oximidosulfonates, bissulfonyldiazomethane compounds, and nitrobenzylsulfonate esters. Suitable photoacid generator compounds are disclosed, for example, in U.S. Pat. Nos. 5,558,978 and 5,468,589, which are incorporated herein by reference. Other suitable photoacid generators are perfluoroalkyl sulfonyl methides and perfluoroalkyl sulfonyl imides as disclosed in U.S. Pat. No. 5,554,664.

Examples of sensitizers useful in this context include, but are not limited to: 9-methylanthracene, anthracenemethanol, acenaphthene, thioxanthone, methyl-2-naphthyl ketone, 4-acetylbiphenyl, 1,2-benzofluorene.

The latent crosslinker of this invention should contain at least two —N—(CH₂—OR²⁵)ₐ units (a=1 or 2). When such a structure interacts with an acid, formed after PAG irradiation, a carbocation is believed to be formed (U.S. Pat. No. 5,512,422): 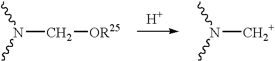
The carbocation formed from the crosslinker can then react with an OH group in a polymer chain or undergo a Friedel Crafts reaction with an aromatic ring. Reaction of two or more such sites of the crosslinker with two or more polymer chains results in crosslinks. The crosslinks render the polymer less soluble in developer and creates the solubility differential with the unexposed areas necessary for image formation. Enough crosslinks render it insoluble.

The polybenzoxazole precursor polymer(s), the photoactive agent(s), and the crosslinker(s) are dissolved in a solvent(s) to prepare the negative working, photosensitive composition of this invention. The solvent should not interfere with the photoacid generation from PAG or with the acid-catalyzed crosslinking reaction, should dissolve all components and should cast a good film. Suitable solvents include, but are not limited to, polar organic solvents, such as gamma-butyrolactone (GBL), propylene glycol methyl ether acetate (PGMEA), methoxy ethyl ether and mixtures thereof. The preferred solvent is gamma-butyrolactone.

Examples of the negative tone compositions suitable for this embodiment and components employed therein, include, but are not limited to those described in U.S. Pat. No. 6,924,841, and US Patent Publication No. 2004/0253537, all incorporated herein by reference.

Subsequent to the bake step, the resulting film is exposed to actinic rays in a preferred pattern through a mask. X-rays, electron beam, ultraviolet rays, visible light, and the like can be used as actinic rays. The preferred rays are those with wavelength of 436 nm (g-line), 365 nm (i-line) and 248. The most preferred rays are those with wavelength of 248 nm and 365 nm.

Following exposure to actinic radiation, the exposed and coated substrate is heated to a temperature between about 70° C. and about 150° C. The exposed and coated substrate is heated in this temperature range for a short period of time, typically several seconds to several minutes and may be carried out using any suitable heating means. Preferred means include baking on a hot plate or in a convection oven. This process step is commonly referred to in the art as post exposure baking.

The process of this embodiment may be employed to produce electronic components such as semiconductor devices and multi-layered interconnections boards.

Another embodiment of the present invention is directed to a process for forming a relief pattern using a non-photosensitive polyimide precursor. Non-photosensitive compositions can be used to form high temperature relief patterns when used in combination with a photosensitive composition. A film of the non-photosensitive polyimide precursor composition is formed on a substrate and then overcoated with the photosensitive composition. The photosensitive composition is patterned and developed to provide an image. An image in the underlying non-photosensitive polyimide precursor composition is developed concurrent with the image formation in the photosensitive composition or in a subsequent step.

The process in this embodiment for forming a relief pattern using a non-photosensitive polyimide precursor comprises:
(a) pretreating a substrate using a pretreatment composition comprising one or more compounds of Structure VI, an organic solvent, and optionally an adhesion promoter,
(b) coating, in a first coating step, the pretreated substrate with a composition comprising one or more polyamic acids and a solvent to form a layer of non-photosensitive polyimide precursor composition having a thickness of at least about 0.5 μm,
(c) baking the layer of non-photosensitive polyimide precursor composition at a temperature or temperatures below 140° C. and preferably below 130° C.,
(d) coating, in a second coating step, a layer of a photoresist over the layer of non-photosensitive polyimide precursor composition to form a bilayer coating,
(e) exposing the bilayer coating to radiation to which the photoresist is sensitive,
(f) developing the bilayer coatings, and
(g) removing the remaining photoresist layer, thereby producing an uncured relief image.

The process may include other optional steps. Examples of optional steps include, but are not limited to, the steps of post exposure baking the exposed coated substrate at an elevated temperature prior to developing, rinsing the developed relief image and substrate after development, and treating the substrate with an adhesion promoter as described in an earlier embodiment. Typically the latter optional step is not done when an adhesion promoter is included in the photosensitive composition or the pretreatment composition.

In this embodiment, the suitable substrates, the treatment composition, and the treatment process are as described previously.

The non-photosensitive polyimide precursor composition comprises:
(a) at least one polyamic acid,
(b) at least one organic solvent, and optionally,
(c) at least one adhesion promoter

Polyamic acids suitable for this embodiment have Structure XV: 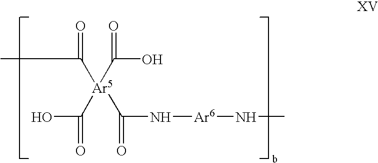
where b is an integer ranging from about 5 to about 200, and Ar⁵ and Ar⁶ can independently be aromatic or aliphatic, and preferably Ar⁶ is a divalent aromatic group, a divalent heterocyclic group, a divalent alicyclic group, a divalent aliphatic group that may contain silicon, or mixtures thereof, and Ar⁵ is a tetravalent aromatic group, a tetravalent heterocyclic group, a tetravalent cycloaliphatic group, or a tetravalent alicyclic group, with the proviso that each valence has at least one of the other valences ortho to it. A preferred range for b is from about 25 to about 175. A most preferred range for b is from about 50 to about 150. Polymer XV should be compatible with other components of the negative-working photosensitive composition and be soluble in the aqueous developer.

The % of polyamic acid polymer of Formula XV in the composition may vary depending on the thickness desired, the molecular weight of the polymer of Formula XV and the viscosity of the coating solvent. The concentration of polyamic acid polymer of Formula XV in the composition is from about 1% to about 25% by weight. A preferred concentration is from about 6% to about 23%. A more preferred concentration is from about 12% to about 22% by weight. The most preferred concentration is from about 16% to about 21% by weight.

The composition used in the present invention also comprises a solvent. Suitable solvents of this composition are polar organic solvents. Suitable examples of polar organic solvents include but are not limited to, N-methyl-2-pyrrolidone (NMP), gamma-butyrolactone (GBL), N,N-dimethylacetamide (DMAc), dimethyl-2-piperidone, N,N-dimethylformamide (DMF), and mixtures thereof. The preferred solvents are gamma-butyrolactone and N-methyl-2-pyrrolidone. The most preferred solvent is gamma-butyrolactone. The amount of total solvent is between about 94% and about 74%. A preferred solvent range is from about 91 wt. % to about 78 wt. %. A more preferred range of solvent is from about 88 wt. % to about 82 wt. %.

Examples of suitable non-photosensitive polyimide precursor compositions include, but are not limited to those described in US Patent Publication No. 2004/0161711, which is incorporated herein by reference.

The non-photosensitive polyimide precursor composition of this invention can optionally contain at least one adhesion promoter. Descriptions of suitable adhesion promoters are described in Patent Publication US2004/0161711A1. The amount of adhesion promoter in the formulation is from about 0.01. to about 2% by weight of the formulation. A preferred amount of adhesion promoter is from about 0.05 wt. % to about 1.5 wt %. A more preferred amount of adhesion promoter is from about 0.15 wt % to about 1 wt % and a most preferred amount is from about 0.2 wt % to about 0.6 wt % of the formulation.

The formulation may also contain various additives such as dyes, dissolution rate modifiers or other additives. The amount of each additive in the formulation, if used, is from about 0.02 to about 2% of the formulation by weight. A preferred amount of each additive, if used, is from about 0.05 to about 1.5% and a more preferred amount is from about 0.1 to about 1% of the formulation by weight.

Suitable means of coating the non-photosensitive polyimide precursor composition have been described above.

After the first coating step, the coated substrate is baked. The baking may take place at one temperature or multiple temperatures. Baking may take place on a hot plate or in various types of ovens known to those skilled in the art. Suitable ovens include ovens with thermal heating, vacuum ovens with thermal heating, and infrared ovens or infrared track modules. Typical times employed for baking will depend on the chosen baking means and the desired time and temperature and will be known to those skilled in the art.

A preferred method of baking is on a hot plate. When baking on a hot plate, typical times range from about 0.5 minute to about 5 minutes at temperatures typically between about 80° C. to about 180° C. Lower bake temperatures and/or times increase the amount of residual solvent in the polyamic acid film, which may cause problems such as intermixing when photoresist is coated.

Higher temperatures and longer bake times can cause imidization of the polyamic acid, resulting in lower dissolution in the developer during lithography. The degree of imidization that occurs during this bake may depend on the specific chemical structure and physical properties of the polyamic acid employed. Thus, optimum baking temperatures may vary with the specific composition. However, for the purposes of this invention the degree of imidization from baking should not prevent dissolution of the non-photosensitive polyimide precursor in the developer.

A preferred baking temperature range is from about 100° C. to about 150° C. A more preferred baking temperature range is from about 115° C. to about 125° C. Other suitable baking temperature ranges are from about 110° C. to less than 140° C. or from about 110C. to less than 130° C. Another suitable temperature range is from about 120° C. to less than 140° C. or from about 120° C. to less than 130° C. Another suitable temperature range may be from about 120° C. to about 135° C.

The thickness of the polyamic acid layer may be from about 100 nm to about 50 μm, depending on the particular application. A preferred thickness range is from about 2 μm to about 40 μm. A more preferred thickness range is from about 4 μm to about 20 μm.

In the second coating step, a layer of photoresist is coated over the film of non photosensitive polyimide precursor composition. Suitable means of coating the photoresist have been described above.

Many photoresists may be suitable for use in this application. The principle characteristics required, in addition to being imageable, are that the photoresists do not intermix with the polyamic acid layer to any significant degree and are developable in aqueous base. Examples of suitable photoresists include, but are not limited to, those based on naphthoquinonediazidesulfonic esters and phenol formaldehyde (novolac) polymers. Examples of this type of photoresist can be found in U.S. Pat. Nos. 5,063,138, U.S. Pat. No. 5,334,481, U.S. Pat. No. 4,377,631, U.S. Pat. No. 5,322,757, U.S. Pat. No. 4,992,596, and U.S. Pat. No. 5,554,797. These photoresists may be employed at exposure wavelengths such as 436 nm or 365 nm. Alternatively DUV photoresists comprising substituted or unsubstituted or protected hydroxystyrene monomer units can also be used, as described in US Patent Publication US2004/0161711, herein incorporated by reference.

Subsequent to the bake step, the resulting film is exposed to actinic rays in a preferred pattern through a mask. X-rays, electron beam, ultraviolet rays, visible light, and the like can be used as actinic rays. The preferred rays are those for which the specific photoresist has been formulated to be sensitive. Examples of those wavelengths include 436 nm (g-line), 365 nm (i-line) and 248 nm.

Following exposure to actinic radiation, the exposed and coated substrate is optionally heated to a temperature between about 70° C. and about 150° C., preferably from about 100° C. to about 130° C. The exposed and coated substrate is heated in this temperature range for a short period of time, typically several seconds to several minutes and may be carried out using any suitable heating means. Preferred means include baking on a hot plate or in a convection oven. This process step is commonly referred to in the art as post exposure baking.

Suitable means for developing the bilayer coating have been described in earlier embodiments.

After the development (or the optional drying step, if employed), the top photoresist layer is removed by dissolving it in an appropriate solvent in a process called “stripping”. The stripping solvent should dissolve the photoresist layer but should not dissolve the bottom layer of polyamic acid. Suitable stripping solvents may include ketones, ethers and esters, such as methyl ethyl ketone, methyl isobutyl ketone, 2-heptanone, cyclopentanone, cyclohexanone, 2-methoxy-1-propylene acetate, 2-ethoxyethyl acetate, I-methoxy-2-propyl acetate, 1,2-dimethoxy ethane, ethyl acetate, cellosolve acetate, propylene glycol monoethyl ether acetate, methyl pyruvate, ethyl pyruvate, methyl 3-methoxypropionate, ethyl 3-methoxypropionate, 1,4-dioxane, diethylene glycol dimethyl ether, and mixtures thereof. Preferred solvents are propylene glycol monoethyl ether acetate, 2-heptanone, cyclohexanone, 2-ethoxyethyl acetate or mixtures thereof. The most preferred solvent is propylene glycol monoethyl ether acetate. The stripping process may be done by immersing the bilayer coated substrate having relief Structures into the stripping solvent or, preferably, by spraying the stripping solvent over the bilayer relief Structures while slowly rotating the substrate on a chuck. Subsequently, the substrate, now having only a polyamic acid relief Structure coated on it, may be rinsed with fresh stripping solvent and dried by suitable drying means.

The polyamic acid is then cured to polyimide by baking the substrate with the polyamic acid relief structure at or above the glass transition temperature, T_{g,} of the polyamic acid polymer to obtain the high heat resistant polyimide. The temperature employed may vary depending on the particular polyamic acid and the substrate employed. The curing temperature may range from about 200° C. to about 500° C. A preferred range is from about 250° C. to about 450° C. A more preferred range is from about 300° C. to about 450° C. The cure may be accomplished using a hot plate, a heated diffusion tube, or oven and may take place at a single temperature, or several temperatures, or be ramped up over a broad temperature range. The cure time will depend on the particular heating means employed, but will typically be from about 30 minutes to about 60 minutes. The atmosphere in which the bake takes place may be in an inert gas, such as nitrogen, or in air.

The process of this embodiment may be employed to produce electronic components such as semiconductor devices and multi-layered interconnections boards.

Another embodiment of the present invention is directed to a process for forming a relief pattern using a negative working photosensitive polyimide precursor composition. The process of this embodiment comprises:
(a) pretreating a substrate using a pretreatment composition comprising one or more compounds of Structure VI, an organic solvent, and optionally an adhesion promoter,
(b) coating on said pretreated substrate, a negative-working photosensitive composition comprising a polyamic ester polymer obtained by polycondensation of at least one diester diacid chloride compound with at least one diamine compound; at least one photoinitiator; at least one polymerization inhibitor and at least one solvent,
(c) exposing the coated substrate to actinic radiation, and
(d) developing the coated substrate with an aqueous developer, thereby forming an uncured relief image.

The process may include other optional steps. Examples of optional steps include, but are not limited to, the steps of post exposure baking the exposed coated substrate at an elevated temperature prior to developing, rinsing the developed relief image and substrate after development, and treating the substrate with an adhesion promoter as described in an earlier embodiment. Typically the latter optional step is not done when an adhesion promoter is included in the photosensitive composition or the pretreatment composition.

In this embodiment, the suitable substrates, the pretreatment composition, and the pretreatment process are as described previously.

The negative working photosensitive polyimide precursor composition suitable for this embodiment of the invention is coated onto the pretreated substrate using coating means described in earlier embodiments. The negative working photosensitive composition suitable for this embodiment of the invention comprises:
(a) a polyamic ester polymer obtained by polycondensation of at least one diester diacid chloride compound with at least one diamine compound,
(b) at least one photoinitiator,
(c) at least one polymerization inhibitor, and
(d) at least one solvent.

A polyamic ester polymer suitable for use in this embodiment has Structure XXII 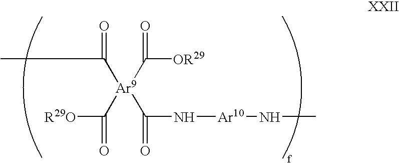
wherein Ar⁹ is a tetravalent aromatic group, a tetravalent heterocyclic group, a tetravalent cycloaliphatic group, or a tetravalent alicyclic group, with the proviso that each valence has at least one of the other valences ortho to I, Ar¹⁰ is a divalent aromatic group, a divalent heterocyclic group, a divalent alicyclic group, a divalent aliphatic group that may contain silicon, or mixtures thereof; each R²⁹ is independently an organic residue with a photopolymerizable double bonds, and f is from about 5 to about 200. Examples of R²⁹ include, but are not limited to, vinyl, allyl, methallyl or a residue of Structure XXIII 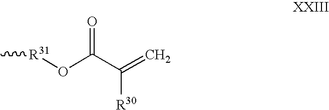
in which R³⁰ is H or Me and R³¹ is —CgH₂g where g is 2 to 12, —CH₂CH(OH)CH₂— or polyoxyalkylene having from 4 to 30 C atoms. Examples of suitable R³¹ groups are ethylene, propylene, trimethylene, tetramethylene, 1,2-butanediyl, 1,3-butanediyl, pentamethylene, hexamethylene, octamethylene, dodecamethylene, —CH₂CH(OH)CH₂—, —(CH₂CH₂0)ₕ—CH₂—CH₂—, —(CH₂CH₂CH₂O)ₕ—CH₂CH₂CH₂— where h is 1 to 6. R³¹ is preferably ethylene, propylene, trimethylene or CH₂CH(OH)CH₂—, and R³⁰ is preferably methyl.

As the photoinitiator component, in principle, any photoinitiator known to those persons skilled in the art may be utilized, which has a sufficiently high sensitivity in the region of the exposure wavelength for which the resist composition is sensitive. Examples of such photoinitiators are, e.g., indicated by K. K. Dietliker in “Chemistry and Technology of UV and EB formulation for Coatings, Inks and Paints”, Volume 3: “Photoinitiators for Free Radical and Cationic Polymerization”. For example, benzoin ethers are suitable, such as, e.g., benzoin methyl ether, ketals, such as diethoxyacetophenone or benzildimethyl ketal, hexaarylbisimidazole, quinones, such as, e.g., 2-tert-butylanthraquinone, or thioxanthones, which are preferably utilized in combination with amine co-initiators, such as, for example, thioxanthone, 2-isopropylthioxanthone or 2-chlorothioxanthone, azides and acylphosphine oxides, such as, e.g., 2,4,6-trimethylbenzoyldiphenyl phosphine oxide.

Other examples of suitable photoinitiators are oxime esters, particularly as named in U.S. Pat. No. 5,019,482, whose description is considered a component of the present description, as well as photoinitiator systems containing ketocoumarins derivatives, as well as amines as activators, such as is described in detail, e.g., in U.S. Pat. No. 4,366,228, whose description is incorporated by reference in the present description.

As photoinitiators (b), the titanocenes known, for example, from U.S. Pat. No. 4,548,891 are preferably utilized. In particular, titanocenes of formulas XXVI to XXIX

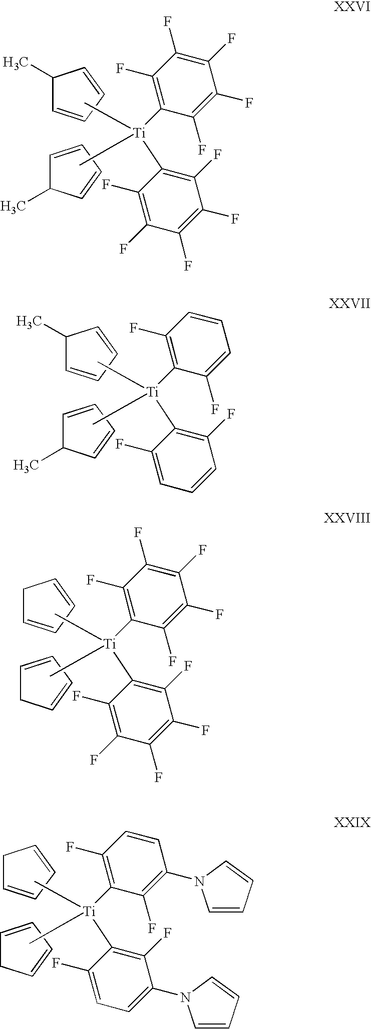

Synthesis procedures for the polyamic acid esters useful in this invention are well known to those skilled in the art. Examples of suitable negative tone photosensitive compositions containing such polyamic acid esters include, but are not limited to, those described in U.S. Pat. No. 6,010,825 and US patent Publication No. 2002/0098444 herein incorporated by reference.

The polymerization inhibitor is selected from the group consisting of para-benzoquinone, thiodiphenylamine, and alkyl phenols such as 4-tert-butylphenol, 2,5-di-tert-butyl hydroquinone, or 2,6-di-tert-butyl-4-methylphenol.

Suitable examples of polar organic solvents include, but are not limited to, N-methyl-2-pyrrolidone (NMP), gamma-butyrolactone (GBL), N,N-dimethylacetamide (DMAc), dimethyl-2-piperidone, N,N-dimethylformamide (DMF), and mixtures thereof. The preferred solvents are gamma-butyrolactone and N-methyl-2-pyrrolidone. The most preferred solvent is N-methyl-2-pyrrolidone

After the coating step, the negative working photosensitive polyimide precursor composition of this embodiment is baked using a baking means described in previous embodiments. The film is baked at a temperature which may range from about 50° C. to about 150° C. to provide a tack free film. The bake time and bake temperature will depend on the particular baking means employed. Bake times may range from about 30 seconds to about 5 minutes for hot plate bakes and for about 1 minute to about 60 minutes for oven bakes.

Subsequent to the bake step, the resulting negative working photosensitive polyimide precursor composition film is exposed to actinic rays in a preferred pattern through a mask. X-rays, electron beam, ultraviolet rays, visible light, and the like can be used as actinic rays. The preferred rays are those for which the specific photoresist has been formulated to be sensitive. Examples of those wavelengths include 436 nm (g-line), 365 nm (i-line) and 248 nm. Preferred wavelengths include, but are not limited to, 436 nm (g-line), 365 nm (i-line), or exposures employing a wide range of wavelengths including 436 nm and 365 nm.

A relief image can be obtained by developing the exposed negative working photosensitive polyimide precursor composition film using developing means described in previous embodiments except with an organic solvent chosen for the specific resist to maximize lithographic properties. Examples of organic solvents which may be employed include, but are not limited to, gamma-butyrolactone, 2-methylpyrollidone, NEP, n-butyl acetate, ethyl lactate, cyclopentanone, cyclohexanone, propylene glycol monomethyl ether acetate, iso-propanol, and binary or ternary mixtures thereof.

The polyamic ester polymer is then cured to polyimide by baking the substrate with the polyamic ester polymer relief Structure at or above the glass transition temperature, T_{g,} of the polyamic ester polymer to obtain the high heat resistant polyimide. The temperature employed may vary depending on the particular polyamic ester polymer and the substrate employed. The curing temperature may range from about 200° C. to about 500° C. A preferred range is from about 250° C. to about 450° C. A more preferred range is from about 300° C. to about 450° C. The cure may be accomplished using a hot plate, a heated diffusion tube, or oven and may take place at a single temperature, or several temperatures, or be ramped up over a broad temperature range. The cure time will depend on the particular heating means employed, but will typically be from about 30 minutes to 6 hours. The atmosphere in which the bake takes place may in an inert gas, such as nitrogen, or in air.

The process of this embodiment may be employed to produce electronic components such as semiconductor devices and multi-layered interconnections boards.

The following examples are provided to illustrate the principles and practice of the present invention more clearly. It should be understood that the present invention is not limited to the examples described. Unless otherwise stated, all percentages are per cent by weight. All pretreatment compositions containing compounds of Structure VI were filtered using a 0.2 μm, Teflon, membrane filter or a Ultradyne™ filter capsule before use.

### SYNTHESIS EXAMPLE 1

### Synthesis of Polybenzoxazole Precursor Polymer of Structure (Ia)

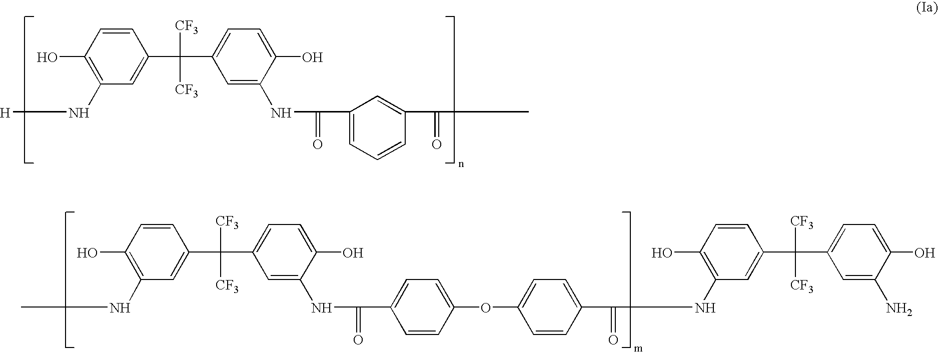

To a 2 L, three-necked, round bottom flask equipped with a mechanical stirrer, nitrogen inlet and addition funnel, 155.9 g (426.0 mmol) of hexafluoro-2,2-bis(3-amino-4-hydroxyphenyl)propane, 64.3 g (794.9 mmol) of pyridine, and 637.5 g of N-methylpyrrolidone (NMP) were added. The solution was stirred at room temperature until all solids dissolved, then cooled in an ice water bath at 0-5° C. To this solution, 39.3 g (194 mmol) of isophthaloyl chloride, and 56.9 g (194 mmol) of 1,4-oxydibenzoyl chloride dissolved in 427.5 g of NMP, were added drop-wise. After the addition was completed, the resulting mixture was stirred at room temperature for 18 hours. The viscous solution was precipitated in 10 liters of vigorously stirred de-ionized water. The polymer was collected by filtration and washed with de-ionized water and a water/methanol (50/50) mixture. The polymer was dried under vacuum conditions at 105° C. for 24 hours.

The yield was almost quantitative and the inherent viscosity (iv) of the polymer was 0.20 dL/g measured in NMP at a concentration of 0.5 g/dL at 25° C.

### SYNTHESIS EXAMPLE 2

### Synthesis of Polybenzoxazole Precursor Polymer of Structure (IIa)

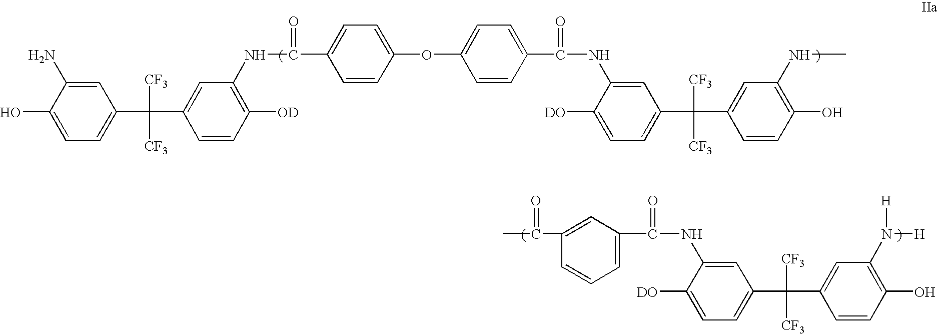

To a 1 L three-necked round bottom flask equipped with a mechanical stirrer, 54.2 g (100 mmol) of the polymer obtained in Synthesis Example 1 and 500 mL of tetrahydrofuran (THF) were added. The mixture was stirred for ten minutes and the solid was fully dissolved. 0.81 g (3 mmole) of 5-naphthoquinone diazide sulfonyl chloride was then added and the mixture was stirred for another 10 minutes. Triethylamine, 0.3 g (3 mmol), was added gradually within 15 minutes and then the reaction mixture was stirred for 5 hours. The reaction mixture was then added gradually to 5000 mL of vigorously stirred de-ionized water. The precipitated product was separated by filtration and washed with 2 L of de-ionized water. To the product was added another 6 L de-ionized water and the mixture vigorously stirred for 30 minutes. After filtration the product was washed with 1 L de-ionized water. The isolated product was dried at 40° C. overnight. The inherent viscosity of the polymer was 0.21 dL/g measured in NMP at the concentration of 0.5 g/dL at 25° C.

### SYNTHESIS EXAMPLE 3

### Synthesis of a Photoactive Compound PAC A

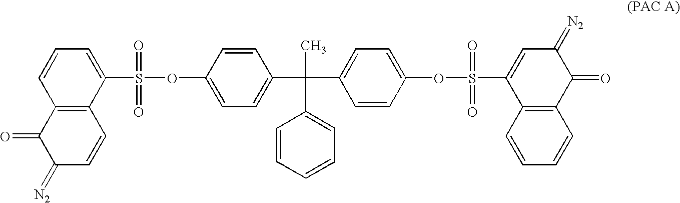

To a 500 mL, 3-neck flask equipped with mechanical stirrer, dropping funnel, pH probe, thermometer and nitrogen purge system were added 225 mL of THF and 30 g of (4,4′-(1-phenylethylidene)bisphenol), Bisphenol AP. The mixture was stirred until bisphenol AP was fully dissolved. To this was added 27.75 g of 4-naphthoquinone diazide sulfonyl chloride (S214-Cl) and 25 mL of THF. The reaction mixture was stirred until the solid was fully dissolved. 10.48 g of triethylamine dissolved in 50 mL THF was added to the reaction mixture gradually while the pH was kept under 8 during this process. The temperature during this exothermic reaction was kept under 30° C. Upon completion of addition, the reaction mixture was stirred for 48 hours. To this was added 27.75 g of 5-naphthoquinone diazide sulfonyl chloride (S21 5-Cl) and 25 mL of THF and the reaction mixture was stirred for 30 minutes. 10.48 g triethylamine dissolved in 50 mL THF was added to the reaction mixture gradually while the pH was kept under 8 during this process. Again during this exothermic reaction the temperature was kept under 30° C. Upon completion of the addition, the reaction mixture was stirred for 20 hours. The reaction mixture was then added gradually to a mixture of 6 L of DI-water and 10 g of HCl. The product was filtered and washed with 2 L of de-ionized water. The product was then reslurried by using 3 L of de-ionized water, filtered and washed with 1 L of de-ionized water. The product was then dried inside a vacuum oven at 40° C. until the amount of water dropped below 2%. HPLC analysis revealed that the product is a mixture of several esters as shown in Table 1.

TABLE 1

| Structure | DNQ moiety | Example 3 |
|---|---|---|
| 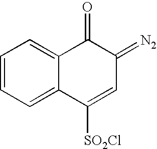 | S214 | 0.61% |
| 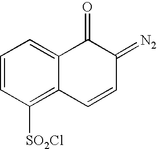 | S215 | 0.53% |
| 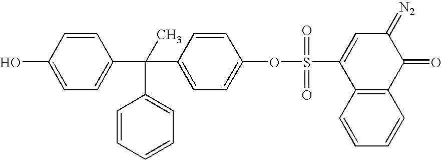 | S214 monoester | 1.72% |
| 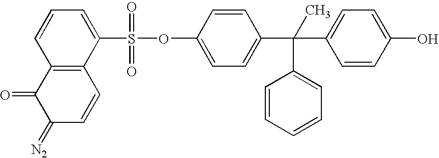 | S215 monoester | 1.4% |
| 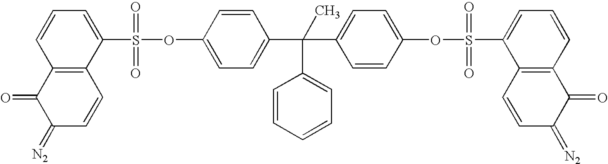 | 5215 diester | 18.9% |
| 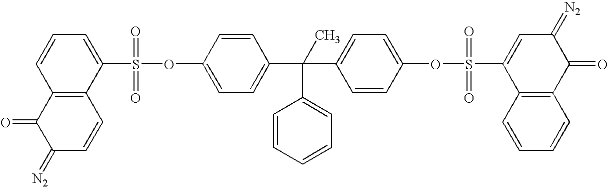 | Mixed Ester PAC | 46.7% |
| 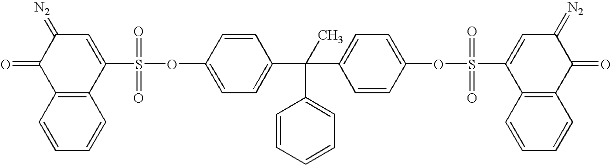 | S214 diester | 29% |

### SYNTHESIS EXAMPLE

### Synthesis of a Photoactive Compound PAC B

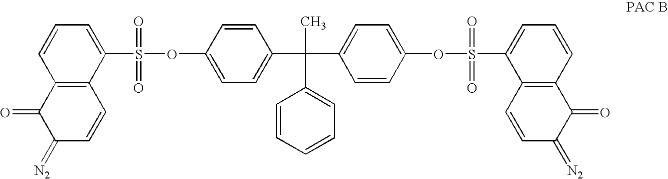

The reaction was similar to that of Synthesis Example 3 except that only 5-naphthoquinone diazide sulfonyl chloride was used. HPLC analysis revealed that about 94% of the product was diester and 6% was monoester.

### FORMULATION EXAMPLE 1

A positive acting photosensitive composition was prepared from 100 parts of a polymer prepared by the method described in Synthesis Example 2, 1.53 parts of gamma-ureidopropyltrimethoxysilane, 2.48 parts of diphenylsilanediol, and 13.51 parts of the PAC synthesized in Synthesis Example 3 and 175 parts GBL and filtered.

### EXAMPLES 1-7 AND COMPARATIVE EXAMPLES 1-4

In Examples 1-7 and Comparative Examples 1-4 a copper wafer was first pretreated with a composition containing 2-mercaptobenzoxazole and GBL except for the wafer employed in Comparative Example 4, which received no pretreatment. The copper wafer substrate was treated for about 10 seconds with 3 ml of the composition applied in a stream while spinning at 200 rpm on a chuck in a lithographic coating tool bowl. The substrate was then dried by accelerating the spin speed to 2000 rpm for 50 seconds.

The copper wafer was then coated with the photosensitive composition of Formulation Example 1 and hotplate baked for 4 minutes at 120° C., resulting in a film thickness of 11 μm. The film was then exposed utilizing an i-line stepper with a patterned exposure array, which incrementally increased exposure energy 30 mJ/cm² after each exposure with a starting exposure energy of 300 mJ/cm². The wafers were then developed using two, 30 second puddles with a 2.38% tetramethyl ammonium hydroxide (TMAH) in H₂O developer solution. The wafers were then inspected visually for residue in the areas where the photosensitive composition had been removed. The results are reported in Table 2.

TABLE 2

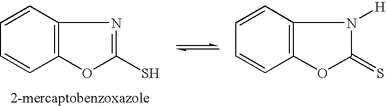

| | Wt % of | Wt% of GBL in | Residue |
|---|---|---|---|
| | 2-mercaptobenzoxazole in | pretreatment | After |
| Example No. | pretreatment composition | composition | Patterning |
| 1 | 15 | 85 | No |
| 2 | 12 | 88 | No |
| 3 | 10 | 90 | No |
| 4 | 7.5 | 92.5 | No |
| 5 | 5 | 95 | No |
| 6 | 2.5 | 97.5 | No |
| 7 | 1.25 | 98.75 | No |
| Comparative | 0.25 | 99.75 | Yes |
| Example 1 | | | |
| Comparative | 0.125 | 99.875 | Yes |
| Example 2 | | | |
| Comparative | 0.0625 | 99.9375 | Yes |
| Example 3 | | | |
| Comparative | No pretreatment | | Yes |
| Example 4 | | | |

### COMPARATIVE EXAMPLES 5-7

In Comparative Examples 5-7 a copper wafer was pretreated with a composition containing 2-mercaptobenzothiazole and GBL according to the procedure in Examples 1-7. The pretreated copper wafer was then coated with the photosensitive composition of Formulation Example 1 and lithographically processed as described in Examples 1-7. The wafers were then inspected visually for residue in the areas where the photosensitive composition had been removed. The results are reported in Table 3.

TABLE 3

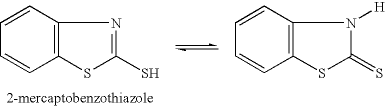

| | Wt % of 2-mercapto- | | |
|---|---|---|---|
| | benzothiazole | Wt % of GBL in | Residue |
| | in pretreatment | pretreatment | After |
| Example No. | composition | composition | Patterning |
| Comparative | 15 | 85 | Yes |
| Example 5 | | | |
| Comparative | 10 | 90 | Yes |
| Example 6 | | | |
| Comparative | 5 | 95 | Yes |
| Example 7 | | | |

Surprisingly, 2-mercaptobenzothiazole showed no ability to prevent residues despite its similarity in structure to 2-mercaptobenzoxazole, which was effective at preventing residues at a significantly lower concentration than the maximum tested for 2-mercaptobenzothiazole.

### FORMULATION EXAMPLE 2

A positive acting photosensitive composition was prepared from 100 parts of a polymer prepared by the method described in Synthesis Example 2, 3 parts of gamma-ureidopropyltrimethoxysilane, 11.9 parts of PAC obtained from Synthesis Example 4, 5 parts of diphenylsilane diol and 175 parts of GBL and filtered.

### EXAMPLES 8-10 AND COMPARATIVE EXAMPLES 8-9

In Examples 8-10 a copper wafer was pretreated with a composition containing 2-mercaptobenzoxazole and GBL according to the procedure described in Examples 1-7. In Comparative Examples 8-9 either there was no pretreatment or a small amount of 2-mercaptobenzoxazole was employed. The copper wafer was then coated with the photosensitive composition of Formulation 2 and lithographically processed as described in Examples 1-7. The wafers were then inspected visually for residue in the areas where the photosensitive composition had been removed. The results are reported in Table 4.

TABLE 4

| | Wt % of | | |
|---|---|---|---|
| | 2-mercaptobenzoxazole in | Wt % of GBL in | Residue |
| | pretreatment | pretreatment | After |
| Example No. | composition (%) | composition | Patterning |
| 8 | 5 | 95 | No |
| 9 | 2.5 | 97.5 | No |
| 10 | 1.25 | 98.75 | No |
| Comparative | 0.25 | 99.75 | Yes |
| Example 8 | | | |
| Comparative | No pre-treatment | | Yes |
| Example 9 | | | |

### EXAMPLES 11-12 AND COMPARATIVE EXAMPLE 10

In Examples 11-12 and Comparative Examples 10 a copper wafer was pretreated with a composition containing 2-mercapto-5-methylbenzimidazole and GBL according to the procedure described in Examples 1-7. The copper wafer was then coated with the photosensitive composition of Formulation Example 1 and lithographically processed as described in Examples 2-8. The wafers then inspected visually for residue in the areas where the photosensitive composition had been removed. The results are reported in Table 5.

TABLE 5

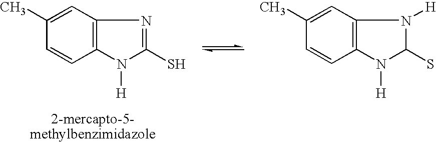

| | Wt % of 2-mercapto-5- | Wt % of GBL in | Residue |
|---|---|---|---|
| | methylbenzimidazole in | pretreatment | After |
| Example No. | pretreatment composition | composition | Patterning |
| 11 | 2 | 98 | No |
| 12 | 1.5 | 98.5 | No |
| Comparative | 1 | 99 | Yes |
| Example 10 | | | |

### COMPARATIVE EXAMPLE 11

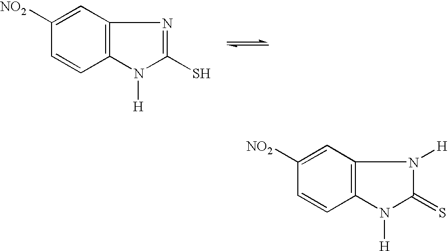

In Comparative Example 11 a copper wafer was pretreated with a composition containing 2-mercapto-5-nitrobenzimidazole (5 wt %) and GBL according to the procedure described in Examples 1-7. The copper wafer was then coated with the photosensitive composition of Formulation Example 1 and lithographically processed as described in Examples 1-7. The wafer was then inspected visually for residue in the areas where the photosensitive composition had been removed. Heavy residue remained in the areas where the photosensitive composition had been removed. The heavy residue was surprising considering the similarity in structure to 2-mercapto-5-methylbenzimidazole, which was effective at preventing residues at a lower concentration (1.5%).

### EXAMPLE 13 AND COMPARATIVE EXAMPLES 12 AND 13

In Example 13 and Comparative Examples 12 and 13 a copper wafer was pretreated with a composition containing 2-mercapto-1-methylimidazole and GBL according to the procedure described in Examples 1-7. The copper wafer was then coated with the photosensitive composition of Formulation Example 1 and lithographically processed as described in Examples 1-7. The wafers were then inspected visually for residue in the areas where the photosensitive composition had been removed. The results are reported in Table 6.

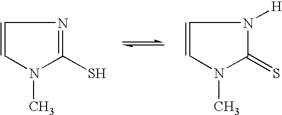

2-mercapto-1 -methylimidazole

TABLE 6

| | Wt % of 2-mercapto-1- | | |
|---|---|---|---|
| | methylimidazole in | Wt % of GBL in | Residue |
| | pretreatment | pretreatment | After |
| Example No. | composition | composition | Patterning |
| 13 | 5 | 95 | No |
| Comparative | 2.5 | 97.5 | Yes |
| Example 12 | | | |
| Comparative | 1.25 | 98.75 | Yes |
| Example 13 | | | |

In Examples 14 to 18 and Comparative Example 14 a copper wafer was pretreated with a composition containing 2-mercaptobenzoxazole and a solvent according to the procedure described in Examples 1-7. The copper wafer was then coated with the photosensitive composition of Formulation Example 1 and lithographically processed as described in Examples 1-7. The wafers were then inspected visually for residue in the areas where the photosensitive composition had been removed. The results are reported in Table 7.

TABLE 7

| | Wt % of 2- | | Wt % of | |
|---|---|---|---|---|
| | mercaptobenzoxazole | | solvent in | |
| | in pretreatment | | pretreatment | Residue After |
| Example No. | composition | Solvent | composition | Patterning |
| 14 | 1.25 | Propylene glycol | 98.75 | No |
| | | monomethyl | | |
| | | ether acetate | | |
| | | (PGMEA) | | |
| 15 | 1.25 | 1-methoxy-2- | 98.75 | No |
| | | propanol | | |
| | | (PGME) | | |
| Comparative | 1.25 | 2-heptanone | 98.75 | Yes |
| Example 14 | | | | |
| 16 | 2.5 | Propylene glycol | 97.5 | No |
| | | monomethyl | | |
| | | ether acetate | | |
| | | (PGMEA) | | |
| 17 | 2.5 | 1-methoxy-2- | 97.5 | No |
| | | propanol | | |
| | | (PGME) | | |
| 18 | 2.5 | 2-heptanone | 97.5 | No |

The results of these experiments indicate that the minimum effective amount of the compound having Structure VI may depend on the nature of the solvent. For 2-mercaptobenzoxazole the minimum amount in GBL, propylene glycol monomethyl ether acetate and 1-methoxy-2-propanol is 1.25% while for 2-hepatanone is 2.5%.

### COMPARATIVE EXAMPLE 15

In Comparative Example 15 a copper wafer was pretreated with a composition containing 0.1% of 2-mercaptobenzimidazole in ethanol according to the procedure described in Examples 1-7. The copper wafer was then coated with the photosensitive composition of Formulation Example 1 and lithographically processed as described in Examples 1-7. The wafer was then inspected visually for residue in the areas where the photosensitive composition had been removed. Heavy residue was found. This Comparative Example shows that the concentration of the compound having Structure VI in a prior art composition was too low to be effective in this application.

### EXAMPLE 19 AND COMPARATIVE EXAMPLES 16 AND 17

In Example 19 and Comparative Example 16 a copper wafer was pretreated with a composition containing 2-mercaptobenzimidazole and a solvent according to the procedure described in Examples 1-7. The copper wafer was then coated with the photosensitive composition of Formulation Example 1 and lithographically was pretreated as described in Examples 1-7. The wafers were then inspected visually for residue in the areas where the photosensitive composition had been removed. The results are reported in Table 8.

TABLE 8

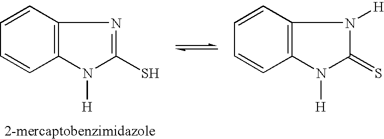

| | Wt % of 2-mercapto- | | Wt % of | |
|---|---|---|---|---|
| | benzimidazole in | | solvent in | Residue |
| Example | pretreatment | | pretreatment | After |
| No. | composition | Solvent | composition | Patterning |
| Comparative | 2.5 | GBL | 97.5 | Yes |
| Example 16 | | | | |
| Comparative | 5* | GBL | 95 | Yes (small |
| Example 17 | | | | amounts) |
| 19 | 5 | NMP | 95 | No |

*The concentration is only approximate because not all of the 2-mercapto-benzimidazole dissolved in the GBL.

This example shows that some solvent selection may be required to obtain a pretreatment solution with an effective amount of the compound having Structure VI.

### SYNTHESIS EXAMPLE 5

### Preparation of Polybenzoxazole Precursor Polymer of Structure Ib

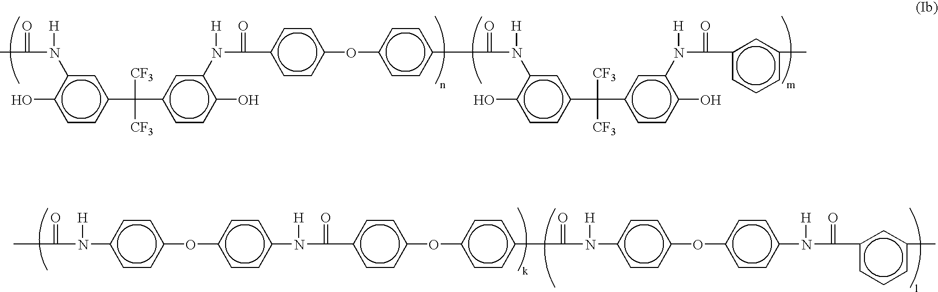 agitator, nitrogen inlet and thermometer, 69.54 g (0.1899 mol) of hexafluoro-2,2-bis(3-amino-4-hydroxyphenyl)propane, 2.0 g (0.0099 mol) of 4,4′-diaminodiphenyl ether, 30.19 g (0.3817 mol) of pyridine and 299.85 g of N-methyl-2-pyrrolidone (NMP) were added. T he solution was stirred at room temperature until all solids dissolved and then cooled in an ice water bath at −15° C. To this solution, 18.4 g (0.091 mol) of isophthaloyl chloride and 26.86 g (0.091 mol) of 1,4-oxydibenzoyl chloride dissolved in 190.3 g of NMP was added by using an addition funnel. After the addition was completed, the resulting mixture was stirred at room temperature for 18 hours. The viscous solution was precipitated in 6.5 L of vigorously stirred de-ionized water. The polymer was collected by filtration and washed with 2×1 L of de-ionized water. The polymer was first air dried for 30 minutes before being reslurried using a mixture of 3200 ml of deionized water and 3200 ml of methanol. The polymer was collected by filtration and washed with 2×1 L of de-ionized water. Polymer was then air dried for 24 hours and then dried under vacuum at 40° C. for 60 hours. The yield was almost quantitative and the inherent viscosity of the polymer was 0.198 dL/g measured in NMP at the concentration of 0.5 g/dL at 25° C.

### SYNTHESIS EXAMPLE 6

### Preparation of Polybenzoxazole Precursor Polymer of Structure IId

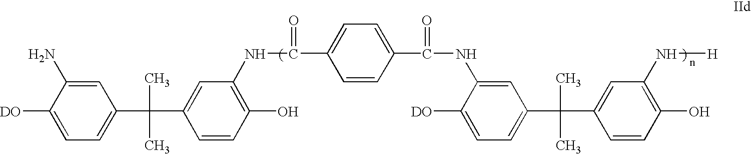

Synthesis Example 2 was repeated except that a polymer prepared according to Synthesis Example 5 was employed and the ratio of 2,1-naphthoquinonediazide-5-sulfonyl chloride to the total number of OH groups of the polymer was changed to 0.0222. The yield was 96% and the inherent viscosity of the polymer was 0.193 dL/g measured in NMP at the concentration of 0.5 g/dL at 25 ° C.

### FORMULATION EXAMPLE 3

40 parts of polymer prepared according to Synthesis Example 6, 13 parts of PAC B prepared with procedure from Synthesis Example 4, 4 parts of diphenylsilanediol and 4.0 parts of triethoxysilylpropylethylcarbamate were dissolved in NMP and filtered.

### EXAMPLES 20 AND 21

A copper wafer was first pretreated with a composition containing 2-mercaptobenzoxazole in GBL. The copper wafer substrate was treated for about 10 seconds with 3 ml of the composition applied in a stream while spinning at 200 rpm on a chuck in a lithographic coating tool bowl. The substrate was then dried by accelerating the spin speed to 2000 rpm for 50 seconds.

The copper wafer was then coated with the photosensitive composition of Formulation Example 3 and hotplate baked for 4 minutes at 120° C., resulting in a film thickness of 11 μm. The film was then exposed utilizing an i-line stepper with a patterned exposure array, which incrementally increased the exposure energy by 30 mJ/cm² after each exposure with a starting exposure energy of 300 mJ/cm². The wafers were then developed using two 30 second puddles with a 2.38% TMAH in H₂O developer solution. The wafers were then inspected visually for residue in the areas where the photosensitive composition had been removed and the results are shown in Table 9.

TABLE 9

| | Wt % of | Wt % of GBL in | Residue |
|---|---|---|---|
| | 2-mercaptobenzoxazole in | pretreatment | After |
| Example No. | pretreatment composition | composition | Patterning |
| 20 | 10 | 90 | No |
| 21 | 1.25 | 98.75 | No |

### SYNTHESIS EXAMPLE 7

### Preparation of Polybenzoxazole Precursor Polymer of Structure Id

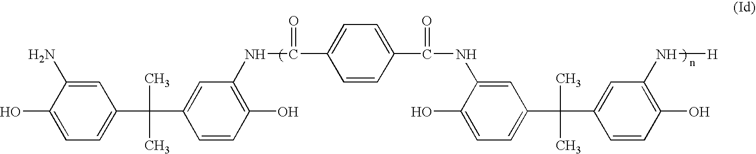

To a 2 L, three-necked, round bottom flask equipped with a mechanical stirrer, nitrogen inlet and addition funnel, 110.0 g (426.0 mmol) of 2,2-bis(3-amino-4-hydroxyphenyl)propane, 64.3 g (794.9 mmol) of pyridine, and 637.5 g of N-methylpyrrolidone (NMP) are added. The solution is stirred at room temperature until all solids are dissolved, then cooled in an ice water bath at 0-5° C. To this solution, 78.6 g (388 mmol) of terephthaloyl chloride in 427.5 g of NMP, is added drop-wise. After the addition is completed, the resulting mixture is stirred at room temperature for 18 hours. The viscous solution is precipitated in 10 liters of vigorously stirred de-ionized water. The polymer is collected by filtration and washed with de-ionized water and a water/methanol (50/50) mixture. The polymer is dried under vacuum conditions at 105° C. for 24 hours.

The yield is quantitative and the inherent viscosity (iv) of the polymer is 0.21 dL/g measures in NMP at a concentration of 0.5 g/dL at 25° C.

### FORMULATION EXAMPLE 4

A positive acting photosensitive composition is prepared from 100 parts of the polymer from Synthesis Example 7, 4.5 parts of gamma-glycidoxypropyltrimethoxysilane, 25 parts of PAC C (structure shown below) and 175 parts GBL and filtered.

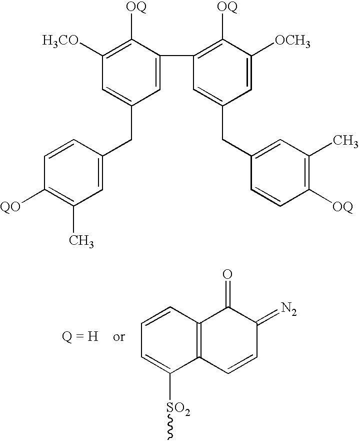

### EXAMPLE 22

A copper wafer is first pretreated with a composition containing 5% 2-mercaptobenzoxazole and 95% GBL. The copper wafer substrate is treated for about 10 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition of Formulation Example 4 and hotplate baked for 4 minutes at 120° C., resulting in a film thickness of 11 μm. The film is then exposed utilizing an i-line stepper with a patterned exposure array, which incrementally increases the exposure energy by 30 mJ/cm² after each exposure with a starting exposure energy of 300 mJ/cm². The wafer is then developed using two 30 second puddles with a 2.38% TMAH in H₂O developer solution. The wafer is then inspected visually for residue in the areas where the photosensitive composition had been removed. There is no residue after patterning.

### SYNTHESIS EXAMPLE 8

### Preparation of Polybenzoxazole Precursor Polymer of Structure IId

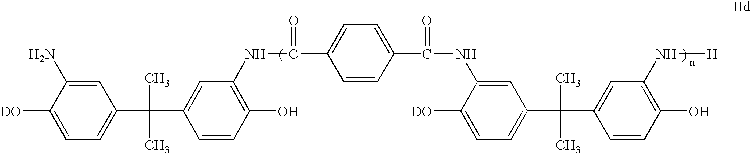

To a 1 L three-necked round bottom flask equipped with a mechanical stirrer, 38.8 g (100 mmol) of the polymer from Synthesis Example 7 and 500 mL of tetrahydrofuran (THF) are added. The mixture is stirred for ten minutes and the solid is fully dissolved. 1.08 g (4 mmole) of 4-naphthoquinone diazide sulfonyl chloride is then added and the mixture is stirred for another 10 minutes. Triethylamine, 0.4 g (4 mmol), is added gradually within 15 minutes and then the reaction mixture is stirred for 5 hours. The reaction mixture is then added gradually to 5000 mL of vigorously stirred de-ionized water. The precipitated product is separated by filtration and washed with 2 L of de-ionized water. To the product is added another 6 L de-ionized water and the mixture vigorously stirred for 30 minutes. After filtration the product is washed with 1 L de-ionized water. The isolated product is dried at 40° C. overnight. The inherent viscosity of the polymer is 0.215 dL/g measured in NMP at the concentration of 0.5 g/dL at 25° C.

### FORMULATION EXAMPLE 5

A positive acting photosensitive composition is prepared from 100 parts of the polymer from Synthesis Example 8, 2.5 parts of gamma-mercaptopropyltrimethoxysilane, 12.5 parts of PAC D (structure shown below), 160 parts GBL and 15 parts PGMEA and filtered.

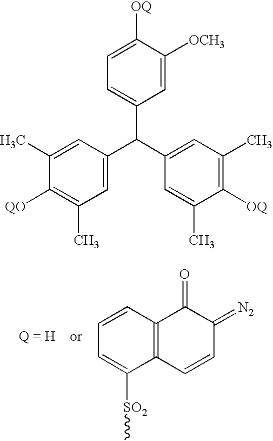

### EXAMPLE 23

A copper wafer is first pretreated with a composition containing 3% 2-mercaptobenzoxazole and 97% GBL. The copper wafer substrate is treated for about 10 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition of Formulation Example 5 and hotplate baked for 4 minutes at 120° C., resulting in a film thickness of 11 μm. The film is then exposed utilizing an i-line stepper with a patterned exposure array, which incrementally increases the exposure energy by 30 mJ/cm² after each exposure with a starting exposure energy of 300 mJ/cm². The wafer is then developed using two 30 second puddles with a 2.38% TMAH in H₂O developer solution. The wafer is then inspected visually for residue in the areas where the photosensitive composition had been removed. There is no residue after patterning.

### FORMULATION EXAMPLE 6

A positive acting photosensitive composition is prepared from 50 parts of the polymer from Synthesis Example 7, 50 parts of the polymer from Synthesis Example 8, 3.5 parts of triethoxysilylpropyl carbamate, 17.5 parts of PAC E (structure shown below), 87.5 parts GBL and 87.5 parts NMP and filtered.

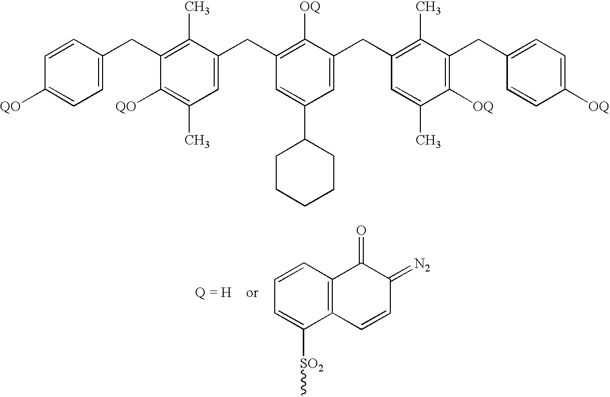

### EXAMPLE 24

A copper wafer is first pretreated with a composition containing 4% 2-mercaptobenzoxazole and 96% GBL. The copper wafer substrate is treated for about 10 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition of Formulation Example 6 and hotplate baked for 4 minutes at 120° C., resulting in a film thickness of 11 μm. The film is then exposed utilizing an i-line stepper with a patterned exposure array, which incrementally increases the exposure energy by 30 mJ/cm² after each exposure with a starting exposure energy of 300 mJ/cm². The wafer is then developed using two, 30 second puddles with a 2.38% TMAH in H₂O developer solution. The wafer is then inspected visually for residue in the areas where the photosensitive composition had been removed. There is no residue after patterning.

### SYNTHESIS EXAMPLE 9

### Preparation of Polybenzoxazole Precursor Polymer of Structure Ic

The synthesis of polymer Ic employed the procedure described in Synthesis Example 1 of patent application except the ratio of 1 ,4-oxydibenzoyl chloride to isophthaloyl chloride changed from 1/1 to 4/1.

### SYNTHESIS EXAMPLE 10

### Preparation of Polybenzoxazole Precursor Polymer of Structure IIc

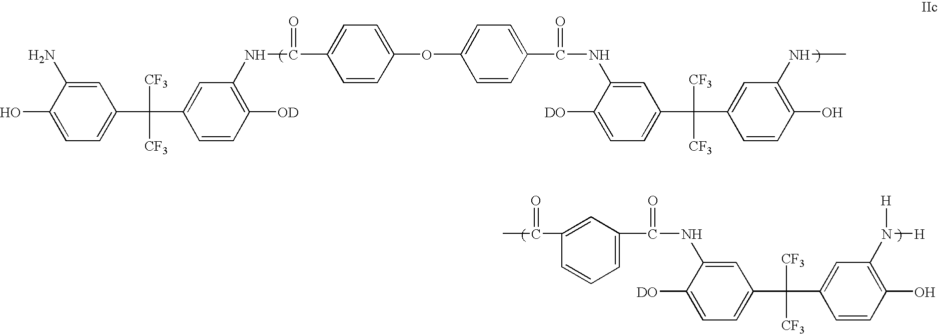

The synthesis of polymer IIc employed the procedure described in Synthesis Example 2, except polymer Ic prepared according to Synthesis Example 9 was used instead of polymer la and the ratio of 5-naphthoquinone diazide sulfonyl chloride to the OH groups was changed from 1.5% to 1%.

### SYNTHESIS EXAMPLE 11

### Preparation of Polybenzoxazole Precursor Polymer of Structure IV*c

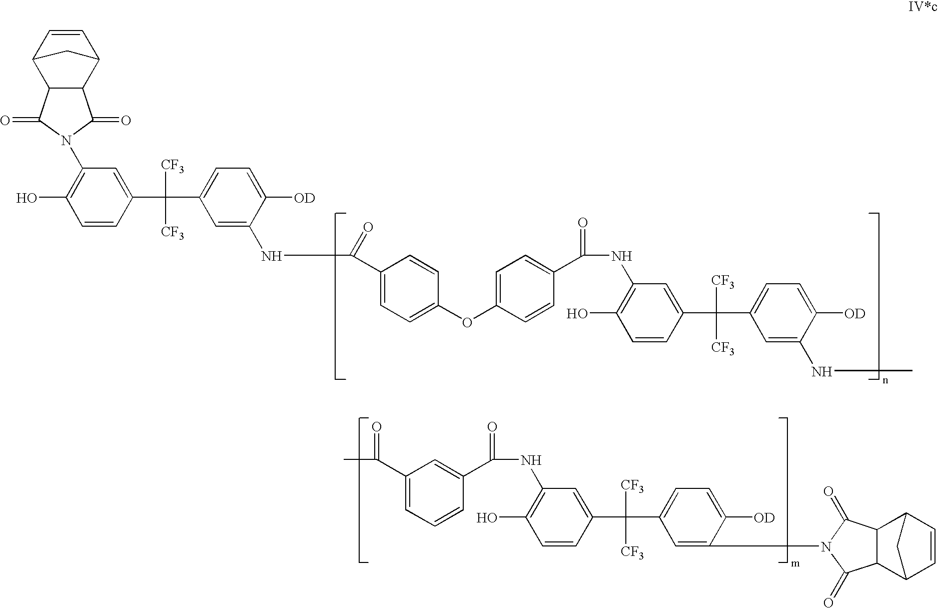

A PBO polymer prepared in the same way as in Synthesis Example 10 (200g) is dissolved in a mixture of 600 g of diglyme and 300 g of propylene glycol methyl ether acetate (PGMEA). Residual water is removed as an azeotrope with PGMEA and diglyme using a rotary evaporator at 65° C. (10-12 torr). About 550 g of solvents is removed during the azeotropic distillation. The reaction solution is placed under a N₂ blanket and equipped with a magnetic stirrer. Nadic anhydride (7 g) is added followed by 10 g of Pyridine. The reaction is stirred overnight at 50° C. Then the reaction mixture is diluted with 500 g of tetrahydrofuran (THF) and precipitated into 8 L of a 50:50 methanol:water mixture. The polymer is collected by filtration and vacuum dried at 40° C. The yield is quantitative.

### FORMULATION EXAMPLE 7

100 parts of the polymer from Synthesis Example 11, 3 parts of N-(3-triethoxysilylpropyl)maleic monoamide, 15 parts of PAC F (structure shown below) are dissolved in 170 parts GBL and 5 parts ethyl lactate and filtered.

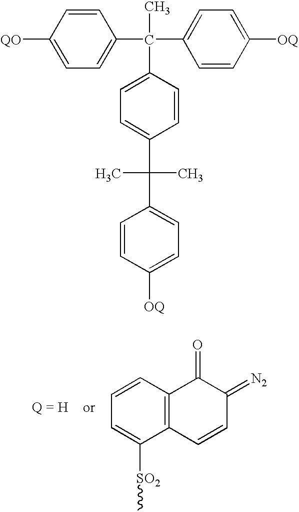

### EXAMPLE 25

A copper wafer is first pretreated with a composition containing 4% 2-mercaptobenzoxazole and 96% GBL. The copper wafer substrate is treated for about 10 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition of Formulation Example 7 and hotplate baked for 4 minutes at 120° C., resulting in a film thickness of 11 μm. The film is then exposed utilizing an i-line stepper with a patterned exposure array, which incrementally increases the exposure energy by 30 mJ/cm² after each exposure with a starting exposure energy of 300 mJ/cm². The wafer is then developed using two 30 second puddles with a 2.38% TMAH in H₂O developer solution. The wafer is then inspected visually for residue in the areas where the photosensitive composition had been removed. There is no residue after patterning.

### SYNTHESIS EXAMPLE 12

### Preparation of a PBO precursor polymer end capped with a p-toluene sulfonic group, structure IIIa′

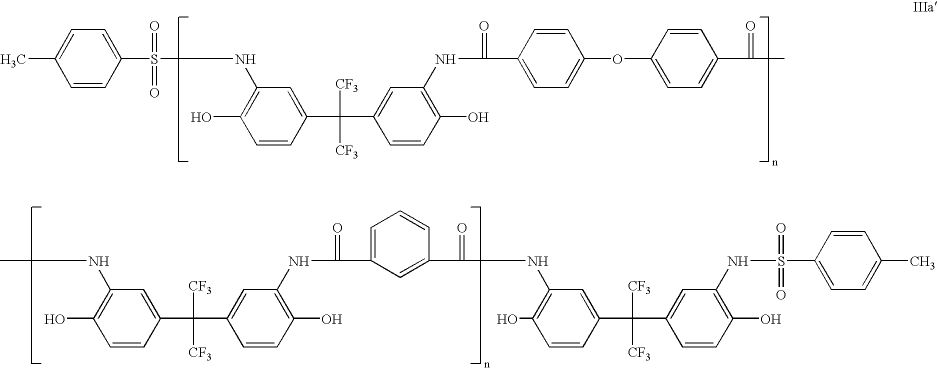

A PBO precursor polymer prepared in the same way as in Synthesis Example 1 (100g) was dissolved in a mixture of 500 g of diglyme and 300 g of propylene glycol methyl ether acetate (PGMEA). Residual water was removed as an azeotrope with PGMEA and diglyme using vacuum distillation at 65° C. (10-12 torr). About 400 g of solvents was removed removed during the azeotropic distillation. The reaction solution was placed under a N₂ blanket. The reaction mixture was cooled on an ice batch down to 5° C. and 3.2 g of Pyridine was added at once followed by 8.5 g of p-Toluene sulfonic acid chloride. The reaction mixture was warmed up to room temperature and stirred overnight.

The reaction mixture was precipitated into 6 L of water with stirring. The precipitated polymer was collected by filtration and air dried overnight. Then, the polymer was dissolved in 500-600 g of acetone and precipitated into 6 L of water/methanol (70/30). The polymer was again collected by filtration and air-dried for several hours. The still damp polymer cake was dissolved in a mixture of 700 g of THF and 70 ml of water. An ion exchange resin UP604 (40 g), available from Rohm and Haas, was added and the solution was rolled for 1 hr. The final product was precipitated in 7 L of water, filtered, air-dried overnight followed by 24 hr drying in vacuum oven at 90° C.

¹H NMR analysis showed absence of any amine peaks at −4.5 ppm as well as absence of aromatic peaks due to the uncapped hexafluoro-2,2-bis(3-amino-4-hydroxyphenyl)propane unit at 6.4-6.7 ppm. This indicates that end capping was complete. Yield: 77 g

### FORMULATION EXAMPLE 8

A positive acting photosensitive composition is prepared from 100 parts of the polymer from Synthesis Example 12, 3.5 parts of N-phenyl-gamma-aminopropyltrimethoxysilane, 22.5 parts of PAC E (structure shown below), 100 parts GBL and 50 parts NMP and filtered. 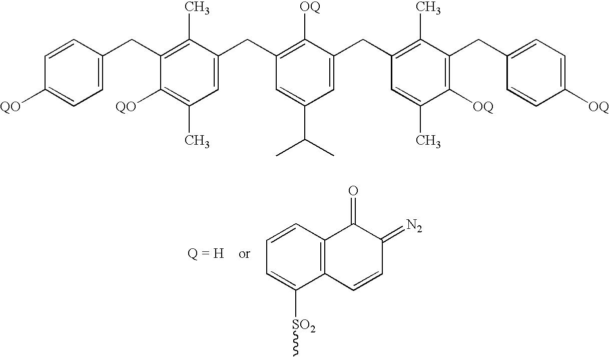
PAC E (50% of OH groups are esterified)

### EXAMPLE 26

A copper wafer is first pretreated with a composition containing 1% 2-mercaptobenzoxazole, 2% 2-mercapto-1-methylimidazole and 97% GBL. The copper wafer substrate is treated for about 15 seconds with 4 ml of the composition applied in a stream while spinning at 250 rpm on a chuck in a lithographic coating tool bowl. The substrate is then dried by accelerating the spin speed to 2500 rpm for 40 seconds.

The copper wafer is then coated with the photosensitive composition of Formulation Example 8 and hotplate baked for 5 minutes at 110° C., resulting in a film thickness of 12 μm. The film is then exposed utilizing an i-line stepper with a patterned exposure array, which incrementally increases the exposure energy by 25 mJ/cm² after each exposure with a starting exposure energy of 250 mJ/cm². The wafer is then developed using two, 35 second puddles with a 2.38% TMAH in H₂O developer solution. The wafer is then inspected visually for residue in the areas where the photosensitive composition had been removed. There is no residue after patterning.

### SYNTHESIS EXAMPLE 13

### Preparation of a DNQ containing PBO precursor polymer end capped with a p-toluene sulfonic group, structure IVa′

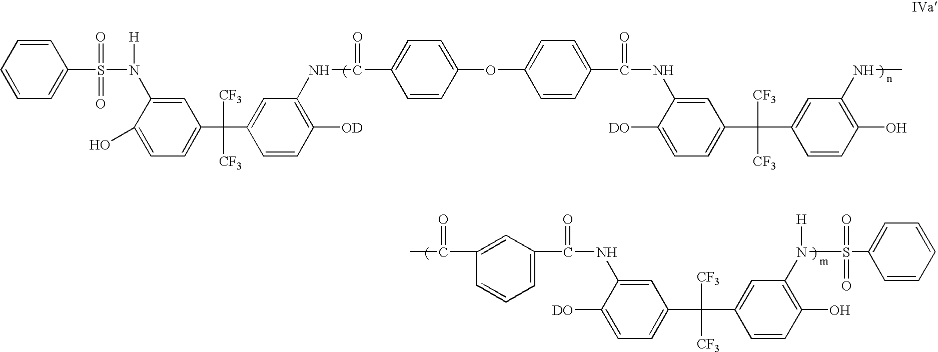

The synthesis of polymer IVa′ employes the procedure described in Synthesis Example 2 of patent application, except polymer IIIa′ from Synthesis Example 12 is used instead of polymer Ia.

### FORMULATION EXAMPLE 9

A positive acting photosensitive composition is prepared from 50 parts of the polymer from Synthesis Example 12, 50 parts of the polymer from Synthesis Example 13, 2.5 parts of gamma-ureidopropyltrimethoxysilane, 18 parts of PAC G (structure shown below), 120 parts GBL and 30 parts PGMEA and filtered.

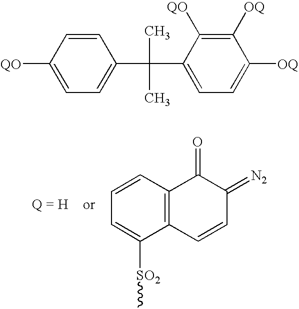

### EXAMPLE 27

A copper wafer is first pretreated with a composition containing 1.5% 2-mercaptobenzoxazole, 0.75% 2-mercapto-5-methylbenzimidazole and 97.75% GBL. The copper wafer substrate is treated for about 25 seconds with 4.5 ml of the composition applied in a stream while spinning at 325 rpm on a chuck in a lithographic coating tool bowl. The substrate is then dried by accelerating the spin speed to 2750 rpm for 35 seconds.

The copper wafer is then coated with the photosensitive composition of Formulation Example 9 and hotplate baked for 4.5 minutes at 115° C., resulting in a film thickness of 12.5 μm. The film is then exposed utilizing an i-line stepper with a patterned exposure array, which incrementally increases the exposure energy by 50 mJ/cm² after each exposure with a starting exposure energy of 150 mJ/cm². The wafer is then developed using one 80 second puddle with a 2.38% TMAH in H₂O developer solution. The wafer is then inspected visually for residue in the areas where the photosensitive composition had been removed. There is no residue after patterning.

### SYNTHESIS EXAMPLE 14

### Preparation of a PBO precursor polymer end capped with 2,6-Dimethoxybenzoyl group, structure IIIa″

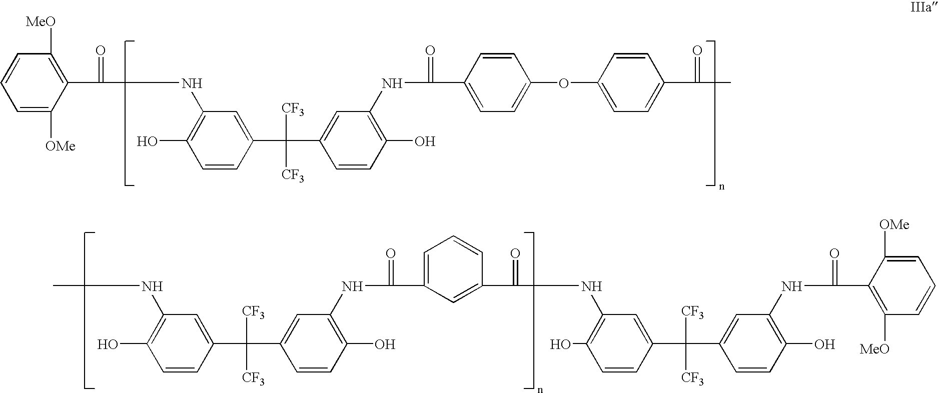

A PBO precursor polymer prepared in the same way as in Synthesis Example 1 (100 g) was dissolved in a mixture of 500 g of diglyme and 300 g of propylene glycol methyl ether acetate (PGMEA). Residual water was removed as an azeotrope with PGMEA and diglyme using vacuum distillation at 65° C. (10-12 torr). About 400 g of solvents was removed removed during the azeotropic distillation. The reaction solution was placed under a N₂ blanket. The reaction mixture was cooled on an ice bath down to 5° C. and 3.2 g of pyridine was added at once followed by addition of 10 g of 2,6-dimethoxybenzoyl chloride over a period of 20 min. The reaction mixture was warmed up to room temperature and stirred overnight.

The reaction mixture was precipitated into 6 L of water with stirring. The precipitated polymer was collected by filtration and air dried overnight. Then, the polymer was dissolved in 500-600 g of acetone and precipitated into 6 L of water/methanol (70/30). The polymer was again collected by filtration and air-dried for several hours. The still damp polymer cake was dissolved in a mixture of 700 g of THF and 70 ml of water. An ion exchange resin UP604 (40 g), available from Rohm and Haas, was added and the solution was rolled for 1 hr. The final product was precipitated in 7 L of water, filtered, air-dried overnight followed by 24 hr drying in vacuum oven at 90° C.

¹H NMR analysis showed absence of any amine peaks at ˜4.5 ppm as well as absence of aromatic peaks due to the uncapped hexafluoro-2,2-bis(3-amino-4-hydroxyphenyl)propane unit at 6.4-6.7 ppm. This indicates that end capping was complete. Yield: 89 g

### FORMULATION EXAMPLE 10

A positive acting photosensitive composition is prepared from 100 parts of the polymer from Synthesis Example 14, 1.5 parts of gamma-glycidopropyltrimethoxysilane, 25 parts of PAC H (structure shown below), 125 parts GBL, 15 parts PGMEA and 10 parts of ethyl lactate (EL) and filtered.

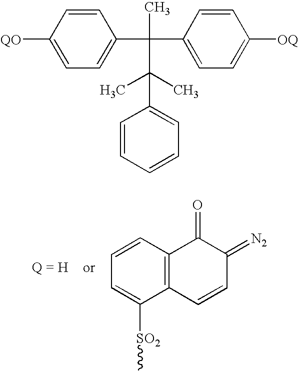

### EXAMPLE 28

A copper wafer is first pretreated with a composition containing 0.5% 2-mercaptobenzoxazole, 1% 2-mercapto-5-methylbenzimidazole, 2% 2-mercapto-1-methylimidazole and 96.5% GBL. The copper wafer substrate is treated for about 35 seconds with 5 ml of the composition applied in a stream while spinning at 400 rpm on a chuck in a lithographic coating tool bowl. The substrate is then dried by accelerating the spin speed to 2800 rpm for 40 seconds.

The copper wafer is then coated with the photosensitive composition of Formulation Example 10 and hotplate baked for 4 minutes at 120° C., resulting in a film thickness of 10.5 μm. The film is then exposed utilizing an i-line stepper with a patterned exposure array, which incrementally increases the exposure energy by 25 mJ/cm² after each exposure with a starting exposure energy of 200 mJ/cm². The wafer is then developed using one 120 second puddle with a 2.38% TMAH in H₂O developer solution. The wafer is then inspected visually for residue in the areas where the photosensitive composition had been removed. There is no residue after patterning.

### FORMULATION EXAMPLE 11

A positive acting photosensitive composition is prepared from 100 parts of the polymer from Synthesis Example 12, 1.5 parts of gamma-glycidopropyltrimethoxysilane, 25 parts of PAC J (structure shown below), 125 parts GBL, 15 parts PGMEA and 10 parts of ethyl lactate (EL) and filtered.

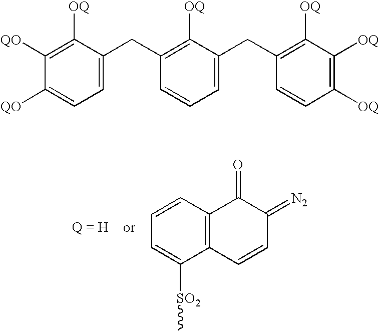

### EXAMPLE 29

A copper wafer is first pretreated with a composition containing 3% 2-mercaptobenzoxazole, and 97% GBL. The copper wafer substrate is treated for about 30 seconds with 3 ml of the composition applied in a stream while spinning at 250 rpm on a chuck in a lithographic coating tool bowl. The substrate is then dried by accelerating the spin speed to 2800 rpm for 40 seconds.

The copper wafer is then coated with the photosensitive composition of Formulation Example 11 and hotplate baked for 3 minutes at 125° C., resulting in a film thickness of 11 μm. The film is then exposed utilizing an i-line stepper with a patterned exposure array, which incrementally increases the exposure energy by 25 mJ/cm² after each exposure with a starting exposure energy of 175 mj/cm². The wafer is then developed using two 60 second puddles with a 2.38% TMAH in H₂O developer solution. The wafer is then inspected visually for residue in the areas where the photosensitive composition had been removed. There is no residue after patterning.

### FORMULATION EXAMPLE 12

A positive acting photosensitive composition is prepared from 50 parts of the polymer from Synthesis Example 12, 50 parts of the polymer from Synthesis Example 13, 3 parts of gamma-glycidopropyltrimethoxysilane, 14 parts of PAC J (shown in Formulation Example 11), 2.5 parts of diphenylsilane diol and 150 parts GBL and filtered.

### EXAMPLE 30

A copper wafer is first pretreated with a composition containing 3% 2-mercaptobenzoxazole, and 97% GBL. The copper wafer substrate is treated for about 30 seconds with 3 ml of the composition applied in a stream while spinning at 250 rpm on a chuck in a lithographic coating tool bowl. The substrate is then dried by accelerating the spin speed to 2800 rpm for 40 seconds.

The copper wafer is then coated with the photosensitive composition of Formulation Example 12 and hotplate baked for 3 minutes at 125° C., resulting in a film thickness of 11 μm. The film is then exposed utilizing an i-line stepper with a patterned exposure array, which incrementally increases the exposure energy by 25 mJ/cm² after each exposure with a starting exposure energy of 175 mJ/cm². The wafer is then developed using two X 40 second puddles with a 2.38% TMAH in H₂O developer solution. The wafer is then inspected visually for residue in the areas where the photosensitive composition had been removed. There is no residue after patterning.

### FORMULATION EXAMPLE 13

A positive acting photosensitive composition is prepared from 100 parts of the polymer from Synthesis Example 14, 3 parts of gamma-ureidopropyltrimethoxysilane, 17 parts of PAC J (shown in Formulation Example 11), 4 parts of diphenylsilane diol and 150 parts GBL and filtered.

### EXAMPLE 31

A copper wafer is first pretreated with a composition containing 3% 2-mercaptobenzoxazole, and 97% GBL. The copper wafer substrate is treated for about 30 seconds with 3 ml of the composition applied in a stream while spinning at 250 rpm on a chuck in a lithographic coating tool bowl. The substrate is then dried by accelerating the spin speed to 2800 rpm for 40 seconds.

The copper wafer is then coated with the photosensitive composition of Formulation Example 13 and hotplate baked for 3 minutes at 125° C., resulting in a film thickness of 11 μm. The film is then exposed utilizing an i-line stepper with a patterned exposure array, which incrementally increases the exposure energy by 25 mJ/cm² after each exposure with a starting exposure energy of 175 mJ/cm². The wafer is then developed using two 40 second puddles with a 2.38% TMAH in H₂O developer solution. The wafer is then inspected visually for residue in the areas where the photosensitive composition had been removed. There is no residue after patterning.

### SYNTHESIS EXAMPLE 15

### Preparation of a PBO precursor polymer III*a end capped with an imide endcap, structure III*a

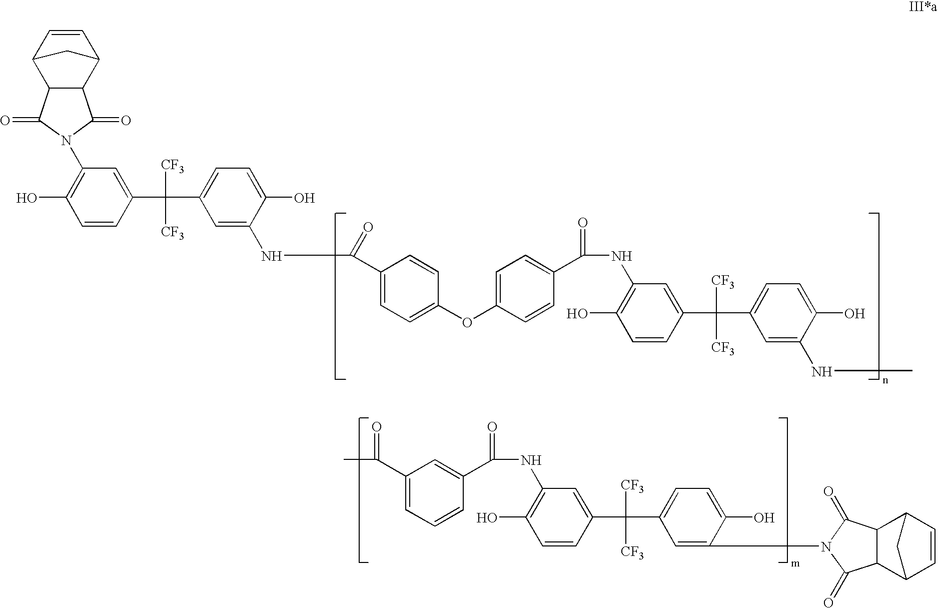

A PBO precursor polymer prepared in the same way as in Synthesis Example 1 (200 g) was dissolved in a mixture of 600 g of diglyme and 300 g of propylene glycol methyl ether acetate (PGMEA). Residual water was removed as an azeotrope with PGMEA and diglyme using a rotary evaporator at 65° C. (10-12 torr). About 550 g of solvents was removed during the azeotropic distillation. The reaction solution was placed under a N2 blanket and equipped with a magnetic stirrer. Nadic anhydride (7 g) was added followed by 10 g of pyridine. The reaction was stirred overnight at 50° C. Then the reaction mixture was diluted with 500 g of tetrahydrofuran (THF) and precipitated into 8 L of a 50:50 methanol:water mixture. The polymer was collected by filtration and vacuum dried at 80° C.

The yield was almost quantitive and the inherent viscosity (iv) of the polymer was 0.20 dL/g measured in NMP at a concentration of 0.5 g/dL at 25° C.

### SYNTHESIS EXAMPLE 16

### Preparation of a DNQ containing PBO precursor polymer III*a end capped with an imide endcap, structure IV*a

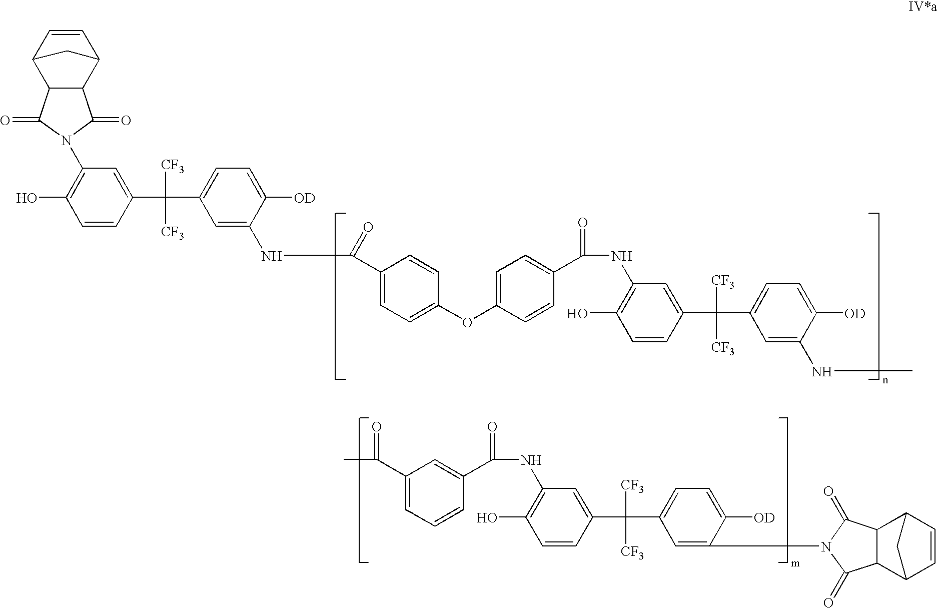

The synthesis of polymer IV*a employs the procedure described in Synthesis Example 2, except polymer III*a from Synthesis Example 15 is used instead of polymer Ia.

### FORMULATION EXAMPLE 14

A positive acting photosensitive composition is prepared from 40 parts of the polymer from Synthesis Example 15, 60 parts of the polymer from Synthesis Example 16, 3 parts of gamma-glycidopropyltrimethoxysilane, 14 parts of PAC J (shown in Formulation Example 11), 2.5 parts of diphenylsilane diol and 150 parts GBL and filtered.

### EXAMPLE 32

A copper wafer is first pretreated with a composition containing 3% 2-mercaptobenzoxazole, and 97% GBL. The copper wafer substrate is treated for about 30 seconds with 3 ml of the composition applied in a stream while spinning at 250 rpm on a chuck in a lithographic coating tool bowl. The substrate is then dried by accelerating the spin speed to 2800 rpm for 40 seconds.

The copper wafer is then coated with the photosensitive composition of Formulation Example 14 and hotplate baked for 3 minutes at 125° C., resulting in a film thickness of 11 μm. The film is then exposed utilizing an i-line stepper with a patterned exposure array, which incrementally increases the exposure energy by 25 mJ/cm² after each exposure with a starting exposure energy of 175 mJ/cm². The wafer is then developed using two 40 second puddles with a 2.38% TMAH in H₂O developer solution. The wafer is then inspected visually for residue in the areas where the photosensitive composition had been removed. There is no residue after patterning.

### SYNTHESIS EXAMPLE 17

### Preparation of PBO Precursor Polymer IIa with acetyl end groups

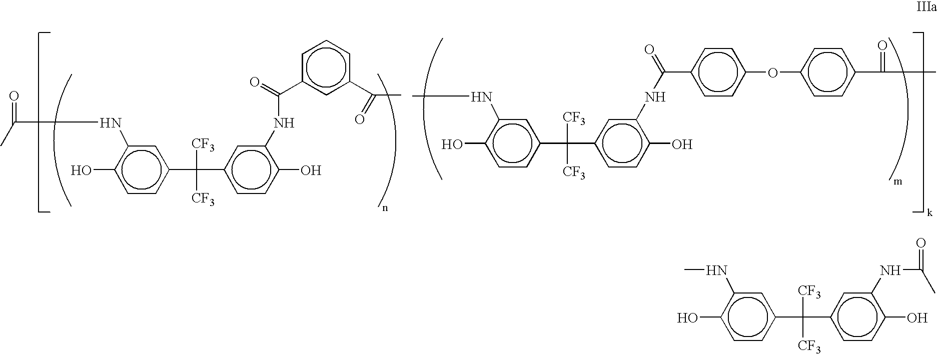

A PBO polymer obtained by the synthetic procedure described in Synthesis Example 1 (100 g) was dissolved in 1000 g of diglyme. Residual water was removed as an azeotrope with diglyme using a rotary evaporator at 65° C. (10-12 torr). About 500 g of solvent was removed during the azeotropic distillation. The reaction solution was placed under a N₂ blanket, equipped with a magnetic stirrer and cooled using an ice bath down to −5° C. Acetyl chloride (3.3 ml, 3.6 g) was added via syringe. The reaction was held on the ice bath for about 10 min. Then the ice bath was removed and the reaction was allowed to warm up over the period of 1 hr. Then, the mixture was again cooled to 5° C. on the ice bath. Pyridine (3.7 ml, 3.6 g) was added via syringe over the period of 1 hr. The reaction was kept on the ice bath for 10 m in following the pyridine addition, and then was allowed to warm up over the period of 1 hr.

The reaction mixture was precipitated into 6 L of water with stirring. The precipitated polymer was collected by filtration and air dried overnight. Then, the polymer was dissolved in 500-600 g of acetone and precipitated into 6 L of water/methanol (70/30). The polymer was again collected by filtration and air-dried for several hours. The still damp polymer cake was dissolved in a mixture of 700 g of THF and 70 ml of water. An ion exchange resin UP604 (40 g), available from Rohm and Haas, was added and the solution was rolled for 1 hr. The final product was precipitated in 7 L of water, filtered, air-dried overnight followed by 24 hr drying in vacuum oven at 90° C. Yield: 100 G

### SYNTHESIS EXAMPLE 18

### Preparation of 4,4′-oxydiphthalic an hydride (ODPA)/oxydianiline (ODA) polyamic acid

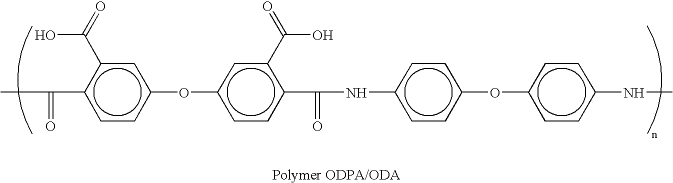

A 500 mL, three neck, round bottom flask was equipped with a mechanical stirrer, temperature controller and nitrogen inlet. 270 g of gamma-butyrolactone was added to this reaction flask followed by addition of 31.022 g (100 mmol) of 4,4′-oxydiphthalic anhydride (ODPA). The ODPA charging funnel was rinsed with 15 g of gamma-butyrolactone. The reaction mixture was stirred at room temperature for 15 minutes and then at 73-75° C. until 4,4′-oxydiphthalic anhydride was fully dissolved. The clear, pale yellow reaction solution was cooled to 15° C. The 4,4′-oxydiphthalic anhydride was partially precipitated. 19.62 g (98 mmol) of oxydianiline was added portion wise over the period of an hour. The oxydianiline container was rinsed with 13.3 g gamma-butyrolactone, which was then added to the reaction solution in one portion. The reaction temperature was kept at 15° C. for another 15 minutes and then slowly increased to 40° C. The reaction mixture was allowed to stir at this temperature for 24 hours. The reaction was complete as evidenced by the absence of an anhydride peak (1800 cm⁻¹) from the IR spectrum of the solution. The viscosity of the final product was 1384 cSt.

### FORMULATION EXAMPLE 15

A photosensitive formulation is prepared by mixing together 100 parts by weight of a PBO precursor polymer, prepared in the same way as in Synthesis Example 17, 200 parts of GBL, 5 parts of (5-propylsulfonyloxyimino-5H-thiophen-2-ylidene)-2-methylphenyl-acetonitrile (PAG 1, shown below), 31.25 parts of ODPA/ODA polymer prepared in Synthesis Example 18, and 10 parts of Powderlink 1174.

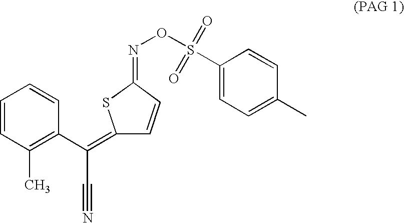

### EXAMPLE 33

A copper wafer is first pretreated with a composition containing 6% 2-mercapto-5-methylbenzimidazole and 94% NMP. The copper wafer substrate is treated for about 15 seconds with 4 ml of the composition applied in a stream while spinning at 250 rpm on a chuck in a lithographic coating tool bowl. The substrate is then dried by accelerating the spin speed to 2500 rpm for 45 seconds.

The copper wafer is then coated with the photosensitive composition of Formulation Example 15 and hotplate baked for 3 minutes at 125° C., resulting in a film thickness of 13 μm. This film is exposed portion wise using incremental exposures on a Cannon 3000i4 exposure tool starting at 50 mJ/cm² incrementing the exposure dose by 50 mJ/cm². The coated, exposed wafer is then baked at 120 ° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### FORMULATION EXAMPLE 16

A photosensitive formulation is prepared by mixing together 100 parts by weight of a PBO precursor polymer, prepared in the same way as in Synthesis Example 15, 180 parts of GBL, 20 parts of PGMEA, 5 parts of (5-propylsulfonyloxyimino-5H-thiophen-2-ylidene)-2-methylphenyl-acetonitrile (PAG 1, structure shown in Formulation Example 15), 27 parts of ODPA/ODA polymer prepared in Synthesis Example 18, 3 parts of beta-(3,4-epoxycyclohexyl)ethyltrimethoxysilane and 10 parts of Powderlink 1174.

### EXAMPLE 34

A copper wafer is first pretreated with a composition containing 2% of 2-mercapto-1-methylimidazole and 98% GBL. The copper wafer substrate is treated for about 10 seconds with 5 ml of the composition applied in a stream while spinning at 300 rpm on a chuck in a lithographic coating tool bowl. The substrate is then dried by accelerating the spin speed to 1500 rpm for 60 seconds.

The copper wafer is then coated with the photosensitive composition of Formulation Example 16 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120 ° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### SYNTHESIS EXAMPLE 19

### Preparation of PBO precursor blocked with ethyl vinyl ether (III*a blocked)

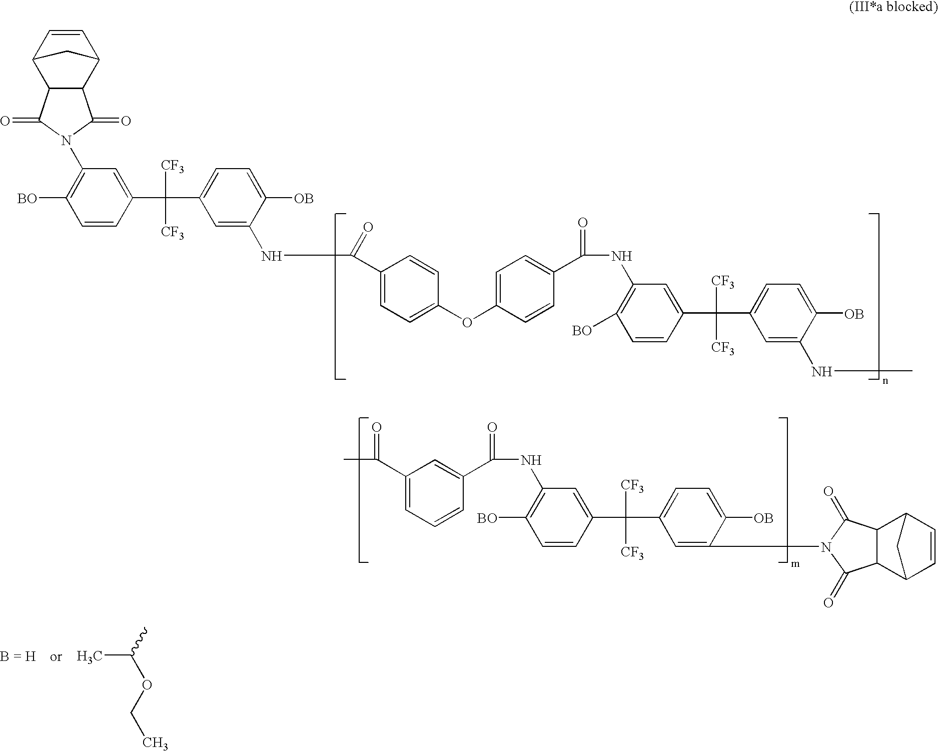

A polymer prepared in the same way as in Synthesis Example Synthesis Example 15 (100 g) was dissolved in 1000 g of diglyme. Residual water was removed as an azeotrope with diglyme using a rotary evaporator at 65° C. (10-12 torr). About 500 g of solvents was removed during the azeotrope distillation. The reaction solution was placed under a N₂ blanket and equipped with a magnetic stirrer. Ethyl vinyl ether (9 mL) was added via syringe, followed by 6.5 ml of 1.5% (wt) solution of p-toluene sulfonic acid in PGMEA. The reaction mixture was stirred for 4 hrs at 25° C. and triethylamine (1.5 ml) was added followed by ethyl acetate (500 ml). 250 ml of water was added and the mixture was stirred for about 30 min. Then the stirring was stopped and organic and water layers were allowed to separate. The water layer was discarded. The procedure was repeated 3 more times. Then, GBL (500 ml) was added and lower boiling point solvents were removed using rotary evaporator at 60° C. (10-12 torr). The solution was precipitated in 5 L of water. The product was collected by filtration and was dried in a vacuum oven at 45 ° C. overnight.

Yield: 90 g. ¹H NMR showed that ˜17% (mol) of the OH groups in the PBO precursor were blocked with ethyl vinyl ether.

### FORMULATION EXAMPLE 17

80 g of a PBO precursor polymer prepared as described in the Synthesis Example 19, 2.4 g of ureidopropyltrimethoxysilane and 4 g of PAG-1 were mixed with 130 g of GBL in a bottle. The bottle was rolled for 3 days and filtered through a 1 μm Teflon filter.

### EXAMPLE 35

A copper wafer is first pretreated with a composition containing 2% of 2-mercapto-1-imidazole and 98% GBL. The copper wafer substrate is treated for about 10 seconds with 5 ml of the composition applied in a stream while spinning at 300 rpm on a chuck in a lithographic coating tool bowl. The substrate is then dried by accelerating the spin speed to 1500 rpm for 60 seconds.

Then, the filtered formulation prepared in Formulation Example 17 is spin coated onto the prepared copper wafer and baked on a hotplate for 3 minutes at 105° C. to obtain a film of about 8.5 μm in thickness. This film is exposed on a Canon 3000i4 I-line stepper, baked again at 120° C. for 3 min and then developed for 150 seconds using a 0.262N aqueous TMAH solution. This is followed by rinsing with deionized water to provide a relief pattern. The wafer is then inspected visually for residue in the areas where the photosensitive composition had been removed. There is no residue after patterning.

### FORMULATION EXAMPLE 18

A negative acting composition, is prepared by mixing: 37.34 wt. % Polyamic acid ester produced from 4,4′-oxydiphthalic anhydride (ODPA), 4,4′-diaminophenyl ether (ODA) and 2-hydroxyethyl methacrylate (prepared according to the procedures described in European Patent Number EP624826B1, section 1.1), 15 6.54 wt. % of a 20% NMP solution of titanocene corresponding to Structure A, 5.61 wt. % tetraethylene glycol dimethacrylate, 0.07 wt. % para-benzoquinone, 0.74 wt % gamma-glycidoxypropyltrimethoxysilane and 49.64 wt. % N-methylpyrrolidone. After rolling overnight the formulation is filtered.

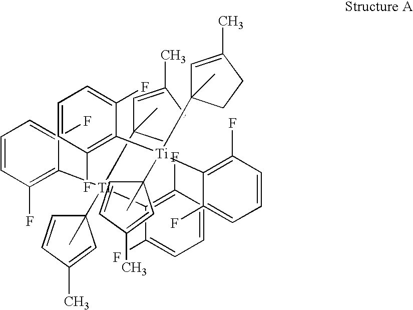

### EXAMPLE 36

A copper wafer is first pretreated with a composition containing 1% 2-mercapto-1-imidazole and 99% GBL. The copper wafer substrate is treated for about 20 seconds with 5 ml of the composition applied in a stream while spinning at 300 rpm on a chuck in a lithographic coating tool bowl. The substrate is then dried by accelerating the spin speed to 2700 rpm for 40 seconds.

The resin solution of the formulation of Example 18 is spin coated onto the wafer and then dried on a hot plate for 7 minutes at 100° C. In this way, 11 μm thick films of uniform thickness is obtained on the wafer. The wafer is then exposed to monochromatic light with a wavelength of 365 nanometers using a Canon 3000i i-line stepper exposure tool. After exposure, the image is developed by rotating the wafers at 1000 rpm and then spraying the wafer with cyclopentanone for 35 seconds, followed by spraying the wafer simultaneously with equal volumes of cyclopentanone and propylene glycol monomethylether acetate (PGMEA) for 10 seconds at 1000 rpm, and then spraying with pure PGMEA for 15 seconds. As a final step, the wafer is spun at 3000 rpm until dry. High quality relief images are obtained. The wafer is then inspected visually for residue in the areas where the photosensitive composition had been removed. There is no residue after patterning.

### FORMULATION EXAMPLE 19

### Preparation of 4,4′-oxydiphthalic anhydride (ODPA)/oxydianiline (ODA) polyamic acid along with adhesion promoter

1 part of ethyl-3-(triethoxysilyl)propylcarbamate was dissolved in 3 parts of gamma-butyrolactone. This solution was added drop-wise to 208 parts of 4,4′-oxydiphthalic anhydride (ODPA)/oxydianiline (ODA) polyamic acid solution prepared according to Synthesis Example 18. The mixture was stirred for 24 hours and a clear solution was obtained which was filtered.

### EXAMPLE 37

### Lithographic Evaluation of 4,4′-oxydiphthalic Anhydride (ODPA)/oxydianiline (ODA) Polyamic Acid Along with Adhesion Promoter in Deep UV Bilayer Process

A copper wafer is first pretreated with a composition containing 5% 2-mercapto-5-benzimidazole and 95% NMP. The copper wafer substrate is treated for about 20 seconds with 5 ml of the composition applied in a stream while spinning at 300 rpm on a chuck in a lithographic coating tool bowl. The substrate is then dried by accelerating the spin speed to 2700 rpm for 40 seconds.

The solution of Formulation Example 19 is spin coated onto the copper wafer. The coated wafer is baked at 120° C. for 3 minutes. The thickness of the film of polyamic acid thus obtained is 7-8 μm. A 2 μm film of a chemically amplified Deep UV photoresist GKR-4401 (commercially available from Fujifilm Electronic Materials, Inc.) is prepared by coating over the polyamic acid layer by spin coating and baking at 110° C. for 90 seconds. The wafer is then exposed using a broadband mercury lamp light for 108.2 seconds (the lamp output is 1000 mJ/cm² at 400 nm during the exposure time) with Karl Suss MA-56 broadband exposure tool. The exposed wafer is then baked at 110° C. for 60 seconds. Then, the pattern is developed in 0.262 N aqueous TMAH using puddle development (2 puddles, 50 seconds each). The remaining photoresist is removed using an atomized spray of photoresist stripper RER 600, which is commercially available from Fujifilm Electronic Materials, Inc.), during a 30 second treatment while s pinning at 2000 revolutions per minute. The wafer is then spun at 3000 revolutions per minute until it is dried. The wafer is then inspected visually for residue in the areas where the photosensitive composition had been removed. There is no residue after patterning.

### FORMULATION EXAMPLE 20

A photosensitive formulation is prepared by mixing together 100 parts by weight of a PBO precursor polymer, prepared in the same way as in Synthesis Example 12, 180 parts of GBL, 20 parts of PGMEA, 5 parts of the PAG 2 shown below, 3 parts of beta-(3,4-epoxycyclohexyl)ethyltrimethoxysilane and 10 parts of Cymel 303.

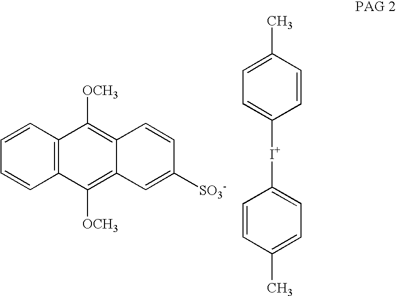

### EXAMPLE 38

A copper wafer is first pretreated with a composition containing 5% of 2-mercapto-1-methylimidazole and 95% GBL. The copper wafer substrate is placed in a wafer boat and immersed for 20 seconds into a bath containing the 2-mercapto-1-methylimidazole composition at 30° C. The wafer boat is removed from the bath and the 2-mercapto-1-methylimidazole composition allowed to drain off the wafer and the wafer boat. The boat is then placed in a spin drier and spun at 1000 rpm for 60 seconds to dry.

The copper wafer is then coated with the photosensitive composition of Formulation Example 20 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120 ° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### FORMULATION EXAMPLE 21

A photosensitive formulation is prepared by mixing together 100 parts by weight of a PBO precursor polymer, prepared in the same way as in Synthesis Example 12, 180 parts of GBL, 20 parts ethyl lactate, and 5 parts of the PAG 3 shown below, and 10 parts of Cymel™ 303.

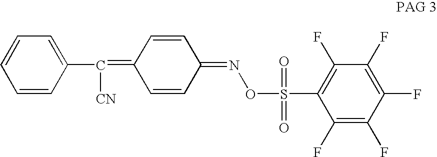

### EXAMPLE 39

A copper wafer is pretreated with a composition containing 4% 2-mercaptobenzoxazole, 1.5% gamma-ureidopropyltrimethoxysilane and 94.5% 2-heptanone. The copper wafer substrate is treated for about 20 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition of Formulation Example 21 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### EXAMPLE 40

A copper wafer is first pretreated with a composition containing 5% of 2-mercapto-1-methylimidazole and 95% GBL. The copper wafer substrate is placed in a wafer boat and immersed for 20 seconds into a bath containing the 2-mercapto-1-methylimidazole composition at 30° C. The wafer boat is removed from the bath and the 2-mercapto-1-methylimidazole composition allowed to drain off the wafer and the wafer boat. The boat is then placed in a spin drier and spun at 1000 rpm for 60 seconds to dry.

The copper wafer is then coated with the photosensitive composition from Formulation Example 17 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120 ° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### FORMULATION EXAMPLE 22

80 g of a PBO precursor polymer obtained in the way described in Synthesis Example 19, and 4 g of the PAG 3 shown below is mixed with 130 g of GBL in a bottle. The bottle is rolled for 3 days and filtered through a 1 μm Teflon filter.

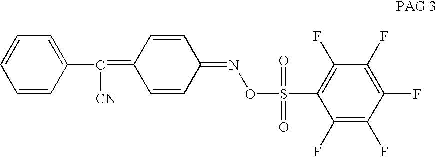

### EXAMPLE 41

A copper wafer is pretreated with a composition containing 4% 2-mercapto-5-methylbenzimidazole, 0.75% gamma-ureidopropyltrimethoxysilane and 95.25% GBL. The copper wafer substrate is treated for about 20 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition from Formulation Example 22 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120 ° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### EXAMPLE 42

A copper wafer is pretreated with a composition containing 5% 2-mercapto-1-methylimidazole, 2% ethyl-3-(triethoxysilyl)propylcarbamate and 93% GBL. The copper wafer substrate is treated for about 20 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition described in Formulation Example 15 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### EXAMPLE 43

A copper wafer is first pretreated with a composition containing 3% of 2-mercaptobenzoxazole and 97% GBL. The copper wafer substrate is placed in a wafer boat and immersed for 15 seconds into a bath containing the 2-mercaptobenzoxazole composition at 30° C. The wafer boat is removed from the bath and the 2-mercaptobenzoxazole composition allowed to drain off the wafer and the wafer boat. The boat is then placed in a spin drier and spun at 1000 rpm for 60 seconds to dry.

The copper wafer is then coated with the photosensitive composition described in Formulation Example 15 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### EXAMPLE 44

A copper wafer is first pretreated with a composition containing 6% of 2-mercapto-1-methylimidazole and 94% GBL. The copper wafer substrate is placed in a wafer boat and immersed for 10 seconds into a bath containing the 2-mercapto-1-methylimidazole composition at 30° C. The wafer boat is removed from the bath and the 2-mercapto-1-methylimidazole composition allowed to drain off the wafer and the wafer boat. The boat is then placed in a spin drier and spun at 1000 rpm for 60 seconds to dry.

The copper wafer is then processed as described in Example 37. The resulting wafer is then inspected visually for residue in the areas where the photosensitive composition had been removed. There is no residue after patterning.

### EXAMPLE 45

A copper wafer is pretreated with a composition containing 5% 2-mercapto-5-methylbenzimidazole, 1% gamma-ureidopropyltrimethoxysilane and 94% GBL. The copper wafer substrate is treated for about 20 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then processed as described in Example 37 except that the polyamic acid formulation did not contain the adhesion promoter. The resulting wafer is then inspected visually for residue in the areas where the photosensitive composition had been removed. There is no residue after patterning.

### EXAMPLE 46

A copper wafer is pretreated with a composition containing 5% 2-mercapto-1-methylimidazole, 1% ethyl-3-(triethoxysilyl)propylcarbamate and 94% GBL. The copper wafer substrate is treated for about 20 seconds with 3 ml of the composition applied in a stream while spinning at 200 rpm on a chuck in a lithographic coating tool bowl. The substrate is then dried by accelerating the spin speed to 2000 rpm for 50 seconds.

The copper wafer is then coated with the photosensitive composition described in Formulation Example 7 with the exception that the solution did not contain an adhesion promoter and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120 ° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

### EXAMPLE 47

A copper wafer is first pretreated with a composition containing 5% of 2-mercapto-1-methylimidazole and 95% GBL. The copper wafer substrate is placed in a wafer boat and immersed for 15 seconds into a bath containing the 2-mercapto-1-methylimidazole composition at 30° C. The wafer boat is removed from the bath and the 2-mercapto-1-methylimidazole composition allowed to drain off the wafer and the wafer boat. The boat is then placed in a spin drier and spun at 1000 rpm for 60 seconds to dry.

The copper wafer is then coated with the photosensitive composition described in Formulation Example 7 and hotplate baked for 5 minutes at 115° C., resulting in a film thickness of 12.5 μm. This film is exposed portion wise using incremental exposures on a Cannon 3000i4 exposure tool starting at 50 mJ/cm² incrementing the exposure dose by 50 mJ/cm². The coated, exposed wafer is then baked at 120° C. for 3 min, developed for 95 seconds under a continuous spray of 0.262N aqueous TMAH solution, and rinsed with de-ionized water to provide a relief pattern. The wafer is then inspected visually for residue in the areas where the photosensitive composition had been removed. There is no residue after patterning.

In the pretreatment and image forming processes of this invention the substrate is preferably a substrate with copper metallization.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. A pretreatment composition for treating a substrate to be subjected to forming a relief pattern thereon by exposure to actinic radiation, the pretreatment composition comprising:
(a) at least one compound having Structure VI 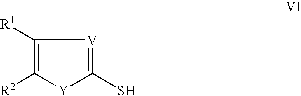
wherein, V is selected from the group consisting of CH and N, Y is selected from the group consisting of O and NR³ wherein R³ is selected from the group consisting of H, CH₃ and C₂H₅, R¹ and R² are each independently selected from the group consisting of H, a C₁-C₄ alkyl group, a C₁-C₄ alkoxy group, cyclopentyl and cyclohexyl, or alternatively, R¹ and R² can be fused to produce a substituted or unsubstituted benzene ring, with the proviso that the substituent is not an electron withdrawing group,
(b) at least one organic solvent, and optionally,
(c) at least one adhesion promoter;
wherein the amount of the compound of Structure VI present in the composition is effective to inhibit residue from forming when the photosensitive composition is coated on a substrate and the coated substrate is subsequently processed to form an image on the substrate.

2. A pretreatment composition according to claim 1 wherein the component of Structure VI is selected from the group consisting of

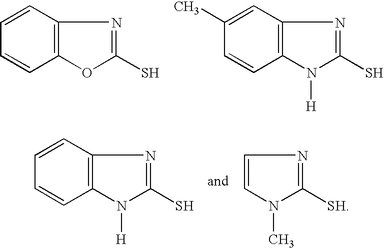

3. A pretreatment composition according to claim 1 comprising an adhesion promoter.

4. A pretreatment composition according to claim 3 wherein the adhesion promoter is a compound of Structure XIV. 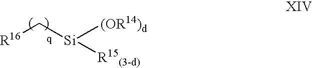
wherein each R¹⁴ is independently selected from the group consisting of a C₁-C₄ alkyl group and a C₅-C₇ cycloalkyl group, each R¹⁵ is independently selected from the group consisting of a C₁-C₄ alkyl group, a C₁-C₄ alkoxy group, a C5-C₇ cycloalkyl group and a C₅-C₇ cycloalkoxy group, d is an integer from 0 to 3 and q is an integer from 1 to about 6, R is selected from the group consisting of one of the following moieties: 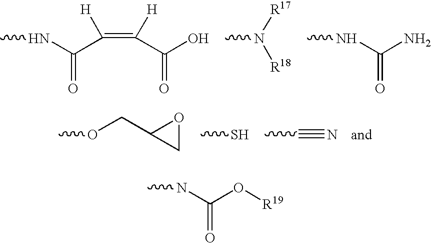
wherein each R¹⁷ and R¹⁸ is independently selected from the group consisting of a C₁-C₄ alkyl group and a C₅-C₇ cycloalkyl group, and R¹9 is selected from the group consisting of a C₁-C₄ alkyl group or a C₅-C₇ cycloalkyl group.

5. A process for pretreating a substrate to be subjected to forming a relief pattern thereon by exposure to actinic radiation, the process comprising treating the substrate with the pretreatment composition according to claim 1 prior to coating the substrate with a photosensitive composition.

6. A process for forming a relief pattern on a substrate, wherein the process is selected from the following processes (I) to (IV):
(II) a process for forming a relief pattern using a positive tone photosensitive composition, the process comprising the steps of:
(a) pretreating a substrate using a pretreatment composition according to claim 1,
(b) coating on the pretreated substrate, a positive-working photosensitive composition comprising at least one polybenzoxazole precursor polymer, at least one diazonaphthoquinone photoactive compound, and at least one solvent, thereby forming a coated substrate,
(c) baking the coated substrate,
(d) exposing the baked coated substrate to actinic radiation, and
(e) developing the exposed coated substrate with an aqueous developer, thereby forming an uncured relief image on the coated substrate;
(II) a process for forming a relief pattern using a chemically amplified positive tone photosensitive composition, the process comprising the steps of:
(a) pretreating a substrate with a pretreatment composition according to claim 1;
(b) coating on said pretreated substrate, a positive-working photosensitive composition comprising at least one polybenzoxazole precursor polymer bearing at least one acid labile functional group; at least one photo acid generator (PAG) and at least one solvent,
(c) baking the coated substrate,
(d) exposing the coated substrate to actinic radiation,
(e) post exposure baking the coated substrate at an elevated temperature, and
(f) developing the coated substrate with an aqueous developer, thereby forming an uncured relief image;
(III) a process for forming a relief pattern using a negative tone photosensitive composition, the process comprising the steps of:
(a) pretreating a substrate with a pretreatment composition according to claim 1,
(b) coating on said substrate, a negative-working photosensitive composition comprising at least one polybenzoxazole precursor polymer, at least one photoactive compound which releases acid upon irradiation, at least one latent crosslinker, and at least one solvent,
(c) baking the coated substrate,
(d) exposing the coated substrate to actinic radiation,
(e) post exposure baking the coated substrate at an elevated temperature, and
(g) developing the coated substrate with an aqueous developer, thereby forming an uncured relief image;
(IV) for forming a relief pattern using a non-photosensitive polyimide precursor, the process comprising the steps of:
(a) pretreating a substrate with a pretreatment composition according to claim 1,
(b) coating, in a first coating step, the pretreated substrate with a composition comprising one or more polyamic acids and a solvent to form a layer of non-photosensitive polyimide precursor composition having a thickness of at least about 0.5 μm,
(c) baking the layer of non-photosensitive polyimide precursor composition at a temperature or temperatures below 140° C.,
(d) coating, in a second coating step, a layer of a photoresist over the layer of non-photosensitive polyimide precursor composition to form a bilayer coating,
(e) exposing the bilayer coating to radiation to which the photoresist is sensitive,
(f) developing the bilayer coatings, and
(g) removing the remaining photoresist layer, thereby producing an uncured relief image; and
(V) a process for forming a relief pattern using a negative working photosensitive polyimide precursor composition, the process comprising the steps of:
(a) pretreating a substrate with a pretreatment composition according to claim 1,
(b) coating on said pretreated substrate, a negative-working photosensitive composition comprising a polyamic ester polymer obtained by polycondensation of at least one diester diacid chloride compound with at least one diamine compound; at least one photoinitiator; at least one polymerization inhibitor and at least one solvent,
(c) exposing the coated substrate to actinic radiation, and
(d) developing the coated substrate with an aqueous developer, thereby forming an uncured relief image.

7. A relief image produced according to a process of claim 6.
